(19) United States
(12) Patent Application Publication
(10) Pub. No.: US 2015/0222712 A1
(43) Pub. Date: Aug. 6, 2015

(54) INFORMATION PROCESSING TERMINAL AND CONTROL METHOD

(71) Applicant: CANON KABUSHIKI KAISHA, Tokyo (JP)

(72) Inventor: Yoshimasa Kawana, Tokyo (JP)

(21) Appl. No.: 14/610,803

(22) Filed: Jan. 30, 2015

(30) Foreign Application Priority Data
Feb. 3, 2014 (JP) 2014-018450

(51) Int. Cl. H04L 29/08

(52) U.S. Cl. CPC H04L 67/141

(57) ABSTRACT

A UA provides a specification screen for specifying one or more relay functions (UAs) that execute a process of registering functional information for calling a function that a service on a network provides. The process of registering functional information is executed by the one or more relay functions specified on the specification screen.

### BACKGROUND OF THE INVENTION

1. Field of the Invention

The present invention relates to a technique for providing services using Web Intents or other frameworks.

2. Description of the Related Art

For delegation of tasks between websites, a caller who calls a function needs to know a method for calling the function, such as an application programming interface (API) or a representational state transfer (REST) interface. Accordingly, to achieve cooperation with another website, the caller is to perform a calling process according to their respective call protocols. Furthermore, the caller often needs authentication of a function provider to use the function. Thus, the user of the function is to store authentication information on the provider and use an authentication base, such as a security assertion markup language (SAML). However, authentication information is to be managed properly and securely. To use an authentication base, such as an SAML, the function provider and the user may have an advance agreement, which places a burden on the user.

Japanese Unexamined Patent Application Publication No. 2009-199369 discloses a technique for using services provided in websites.

Another framework for cooperating with any web service (or web application) without using dedicated API is known. For example, a Web Intents system has been proposed which loosely interconnects a service receiver and a provider using runtime late binding.

In the new cooperation framework, such as Web Intents, to use provided function provided using a service of the system, a user agent (UA) processes an HTML document including a markup for registering functional information on the provided function and registers the functional information as Web Intent. The UA serves as a relay function that interconnects a Web Intents client and a Web Intents service over a network and can request execution of the provided function by connecting to the service using functional information registered in the UA. However, in the case where the information processing terminal includes a plurality of relay functions, the process of registering functional information is performed for each relay function and managed individually. Thus, even if some functional information is registered in one relay function, the functional information cannot be used via another relay function. This may require that the user repeats the registration process for each of the relay functions even for the same functional information, which is not always convenient.

Thus, for requests for services using the Web Intent and registration of Web Intent, various improvements for enhancing the usability will be requested.

### SUMMARY OF THE INVENTION

The present invention provides an apparatus including a plurality of relay functions configured to interconnect a client that manages data and a service that provides a function using the data over a network, and a providing unit configured to provide a specification screen for specifying one or more relay functions that execute a process of registering functional information for calling the function. The process of registering functional information is executed by the one or more specified relay functions.

Further features of the present invention will become apparent from the following description of exemplary embodiments with reference to the attached drawings.

### BRIEF DESCRIPTION OF THE DRAWINGS

FIG. 1 is a diagram illustrating the basic system configuration of Web Intents.

FIG. 2 is a sequence diagram illustrating, in outline, the basic operation of Web Intents.

FIG. 3A is a diagram illustrating an example of a markup for registering Web Intents.

FIG. 3B is a diagram illustrating an example of a markup for registering Web Intents.

FIG. 4 is a diagram illustrating an example of a UI of an information processing terminal in which a plurality of Web browsers are installed.

FIG. 5 is a block diagram illustrating an example hardware configuration of a client and a service.

FIG. 6 is a block diagram illustrating an example hardware configuration of the information processing terminal including UAs.

FIG. 7 is a block diagram illustrating an example software configuration of the information processing terminal including UAs.

FIG. 8 is a diagram illustrating an example of functional information managed by a Web browser.

FIG. 9 is a sequence diagram illustrating an operation of mutual use of functional information in a first embodiment.

FIG. 10A is a diagram illustrating an example of a screen displayed on a Web browser.

FIG. 10B is a diagram illustrating an example of a screen displayed on a Web browser.

FIG. 11A is a detailed sequence diagram of part of the sequence in FIG. 9.

FIG. 11B is a detailed sequence diagram of part of the sequence in FIG. 9.

FIG. 12 is a diagram showing an example of the data configuration of functional information.

FIG. 13 is a flowchart of a process of mutually using functional information in the first embodiment.

FIG. 14 is a flowchart showing the details of the process of registering functional information to other UAs using Intent.

FIG. 15 is a sequence diagram illustrating an operation of mutually using functional information in a second embodiment.

FIG. 16 is a detailed sequence diagram of part of the sequence in FIG. 15.

FIG. 17 is a flowchart showing the details of the process of registering functional information to UAs using Web Intents.

FIG. 18 is a sequence diagram illustrating an operation of mutually using functional information in a third embodiment.

FIG. 19A is a diagram showing an example of a Web browser screen.

FIG. 19B is a diagram showing an example of a Web browser screen.

FIG. 20A is a detailed sequence diagram of part of the sequence in FIG. 18.

FIG. 20B is a detailed sequence diagram of part of the sequence in FIG. 18.

FIG. 20C is a detailed sequence diagram of part of the sequence in FIG. 18.

FIG. 21A is a diagram illustrating a map of functional information.

FIG. 21B is a diagram illustrating a map of functional information.

FIG. 21C is a diagram illustrating a map of functional information.

FIG. 22 is a flowchart of a process of mutually using functional information in the third embodiment.

FIG. 23 is a flowchart showing the details of the process of creating a map.

FIG. 24 is a flowchart showing the details of the process of obtaining functional information.

FIG. 25A is a flowchart showing the details of the process of sharing functional information.

FIG. 25B is a flowchart showing the details of the process of sharing functional information.

FIG. 26 is a sequence diagram illustrating an operation of mutually using functional information in a fourth embodiment.

FIG. 27A is a detailed sequence diagram of part of the sequence in FIG. 26.

FIG. 27B is a detailed sequence diagram of part of the sequence in FIG. 26.

FIG. 28A is a detailed sequence diagram of part of the sequence in FIG. 26.

FIG. 28B is a detailed sequence diagram of part of the sequence in FIG. 26.

### DESCRIPTION OF THE EMBODIMENTS

Embodiments of the present invention will be described with reference to the drawings.

### First Embodiment

### Basic Mechanism of Web Intents

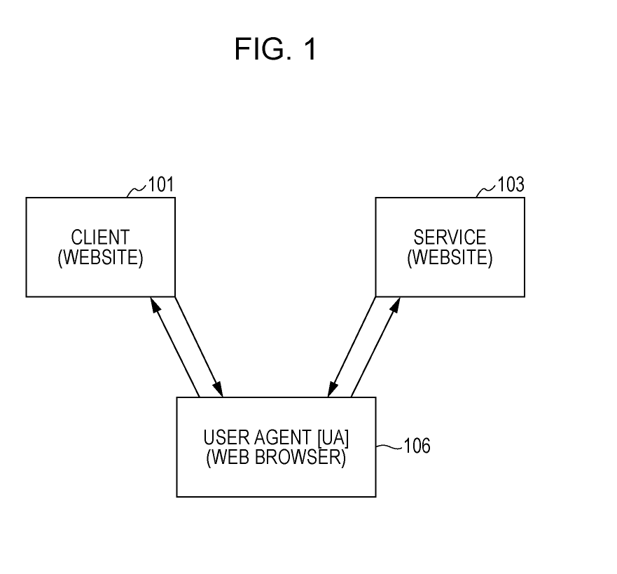

The basic mechanism of Web Intents, which is an example of a framework for cooperating with any Web service (or Web application) without using a dedicated API, will first be described with reference to FIGS. 1 to 3B. While, in some embodiments of the present invention, Web Intents is taken as a specific example, another similar framework may be applied as a technique for cooperating with any Web service (or Web application).

FIG. 1 is a diagram illustrating the overall configuration of Web Intents.

In FIG. 1, reference numeral 103 denotes a Web Intents service (hereinafter referred to as a service) that provides services and functions using a Web Intents technique. Reference numeral 101 denotes a Web Intents client (hereinafter referred to as a client) that uses the service 103. Reference numeral 106 denotes a user agent (hereinafter referred to as a UA) that plays a role in passing a request from the client 101 to the service 103 and passes a result from the service 103 to the client 101. In other words, the UA 106 is a relay function for making a request and transferring data between the client 101 and the service 103. The UA 106 holds Web Intent, which is functional information for calling a function provided by the service 103.

In this framework, for example, the client 101 is a website that manages data and in which a service call button and so on are disposed, and the UA 106 is a Web browser that displays the website. The service 103 is a website cooperating with the client 101, which receives data managed by the client 101 via the UA 106 and processes the data.

For example, if this framework is applied to a social networking service (SNS), the service 103 serves as a posting service that receives posted pictures or comments managed by the client 101 to make up a browsing site. If the Web Intents framework is described taking social buttons in an SNS site, such as “like”, “check”, and “share”, as an example, the client 101 serves as a site in which the buttons are disposed, the UA 106 serves as a Web browser, and the service 103 serves as a posting destination of the button “like” or the like. If user authentication or user's operation is needed when the service 103 provides a function, the user performs the operation on the UA 106.

The UA 106, if having a function for cooperating with a service, described later, can be implemented by, in addition to the Web browser, an operating system (OS) or an application that operates on an information processing terminal. Examples of the information processing terminal include a personal computer, a smartphone, a tablet computer, and a car navigation system.

The service 103 may include not only a service provider on the Internet, such as the above posting destination service, but also a camera, a printer, and a scanner built in an information processing terminal. The service 103 may further include, as a service provider, peripheral devices, such as a printer, a scanner, and a network camera and home electric appliances, such as a refrigerator and a television set, connected over a network. Likewise, the client 101 may include, as service user, various devices and applications built in an information processing terminal, peripheral devices and home electric appliances on a network, and programs operating thereon. Any combinations of the client 101, the UA 106, and the service 103 may operate on an identical system.

Specifically, a document editing application having the same function as that of a Web browser may operate as a configuration including the client 101 and the UA 106. Any of the client 101, the UA 106, and the service 103 may operate on an identical system.
Sequence diagram of Web Intents and examples of data

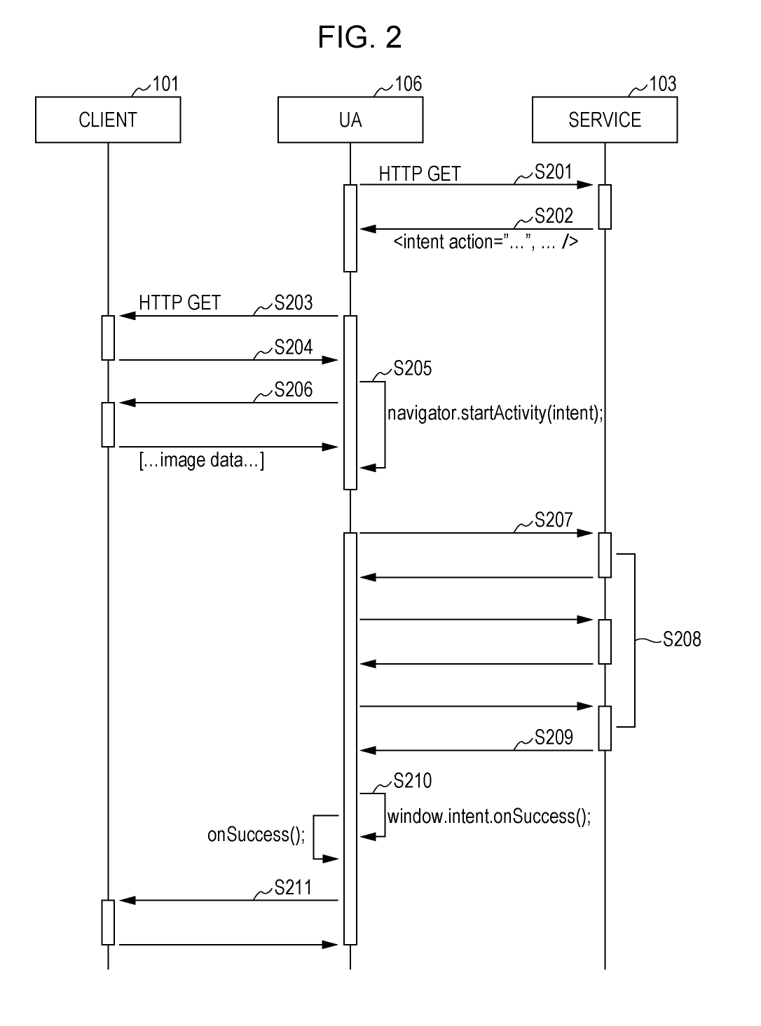

FIG. 2 is a sequence diagram illustrating a basic operation for providing services using Web Intents.

At S201, the UA 106 accesses the service 103 by user operation. At S202, the service 103 sends a HyperText Markup Language (HTML) response including a registration markup for having a function that the service 103 provides registered in the UA 106 to the UA 106.

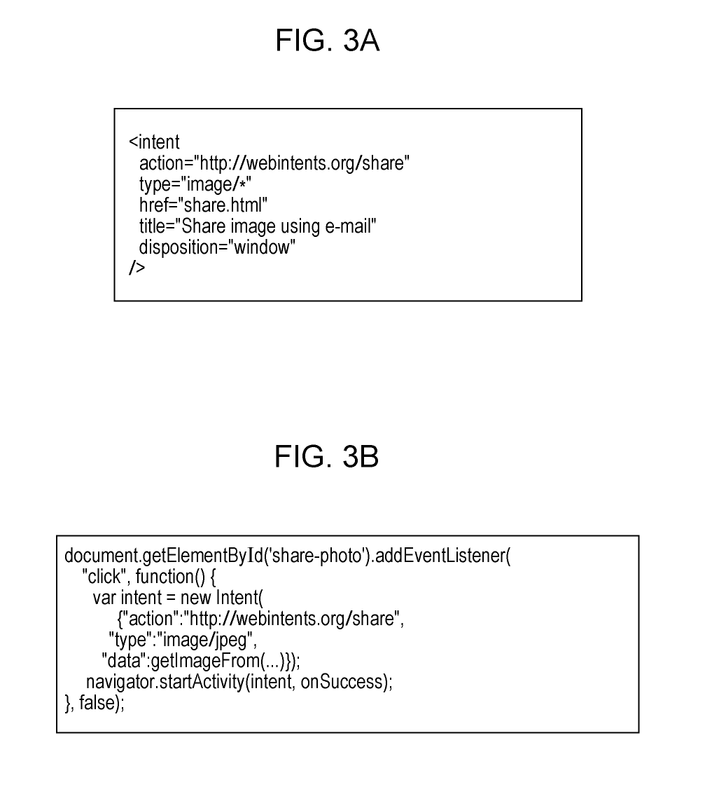

FIG. 3A is a diagram illustrating an example of the HTML document returned from the service 103 to the UA 106 at S202. The content of the HTML document returned from the service 103 to the UA 106 will be described hereinbelow with reference to the example in FIG. 3A.

An <intent> tag describes functional information for specifying and calling a function that the service 103 provides. “Action” designates category information on the provided function. That is, “action” is category information indicating what function or service is provided by the function. Examples of the category information on the provided function include category information “Share” corresponding to a function of sharing data, category information “Edit” corresponding to a function of editing data, category information “View” corresponding to a function of viewing data, category information “Pick” corresponding to a function of obtaining data, and category information “Save” corresponding a function of saving data. In other words, the functional information describes category information indicating Share, Edit, View, Pick, or Save.

The term “type” indicates the type of data that the provided function can deal with. In other words, “type” indicates a data type that can be dealt with for the action. The term “href” indicates the destination (URL) of the provided function. The term “title” indicates the title of the provided function. The term “disposition” indicates how the called provided function” is to be displayed.

In the example of FIG. 3A, the category of the provided function is “share”, the type of data that can be dealt with is “all formats of (*) image data”, and the destination is “share.html”. The title is “Share image using e-mail”. This function can be displayed in another window via the UA 106.

Upon receiving the HTML response returned at S202, the UA 106 asks the user whether to register the function provided by the service 103 in the UA 106. For example, if the UA 106 is a Web browser, the UA 106 displays a popup window to prompt the user to determine whether to register the provided function. When the user determines to register the provided function as Web Intent, the UA 106 executes a registration process of storing the information received at S202 therein. Specifically, the information received at S202 is stored in a storage area of an information processing terminal in which the UA 106 operates and is registered as Web Intents in the UA 106.

At S203, the UA 106 accesses the client 101 according to user operation. At S204, the client 101 returns a HTML document that describes using the function (Web Intent) provided by the service 103 to the UA 106. For example, in the case where an image and a “share” button are displayed in the website or the client 101, the website returns an HTML document including ECMAScript, as shown in FIG. 3B, which is a process request using the Web Intent, to the UA 106.

FIG. 3B is a diagram illustrating an example of the HTML document returned from the client 101 to the UA 106 at S204. The content of the HTML document returned from the client 101 to the UA 106 will be described hereinbelow with reference to the example in FIG. 3B.

The ECMAScript indicates that when a button having an ID “share-photo” in the HTML is clicked, a designated unnamed function is executed. The unnamed function first creates a new Intent object and calls a startActivity( ) function using the Intent object as an argument. Upon executing the function, the UA 106 extracts Web Intents whose action and type match the designated Web Intent object from Web Intents registered therein and displays a list thereof, thereby requesting the user to select one. The UA 106 executes a getImageFrom( ) function called in the unnamed function to obtain image data in the client 101.

At S204, the UA 106 receives the HTML document transmitted from the client 101 and displays a screen based on the HTML document. Upon detecting that the user pressed the “share” button on the screen at S205, the UA 106 executes the ECMAScript for starting Web Intents, as described above, and at S206, obtains image data of the client 101. When the UA 106 detects the press of the “share” button at S205, the UA 106 displays a list of Web Intents registered in the UA 106. When the UA 106 detects that the user selected a Web Intent indicating a function provided by the service 103 from the list, at S207, the UA 106 transmits a HTTP request (a request to process the Web Intent) to the service 103 that provides the selected function. At that time, the UA 106 adds the content of the Web Intent object that the ECMAScript in FIG. 3B created to the transmission data.

Upon receiving the HTTP request transmitted from the UA 106 at S207, the service 103 extracts the Web Intent object from the HTTP request at S208 and implements using the selected function (in this case, “share” of the image data in the client 101) while interacting with the user via the UA 106.

For example, suppose that the user visits a site in which a Web Intents call button for a Web storage (the client 101) that manages photographic data via the Web browser (the UA 106) and presses the button. Then the Web browser (the UA 106) displays a popup window containing a registration service list. If the user selects a Web mail function as a service on the popup window, a site that provides the function is displayed on another window, and a new mail to which photographic data is attached is created as a result of process on the window. Thus, the user can send the e-mail.

When the process for the provided function ends, the service 103 returns a response including ECMAScript that notifies the client 101 of the process result to the UA 106 at S209. Upon receiving the response sent at S209, the UA 106 executes the ECMAScript included in the response at S210 to call a call back function onSuccess( ) specified by the argument in the startActivety( ) function executed at S205. At S211, the UA 106 returns the process result to the client 101 according to the call back function onSuccess( ).

The above process allows the client 101 to call a function of Web Intents that the service 103 provides (in this example, “share” of an image) via the UA 106.

### Example of UI of Information Processing Terminal in Embodiment

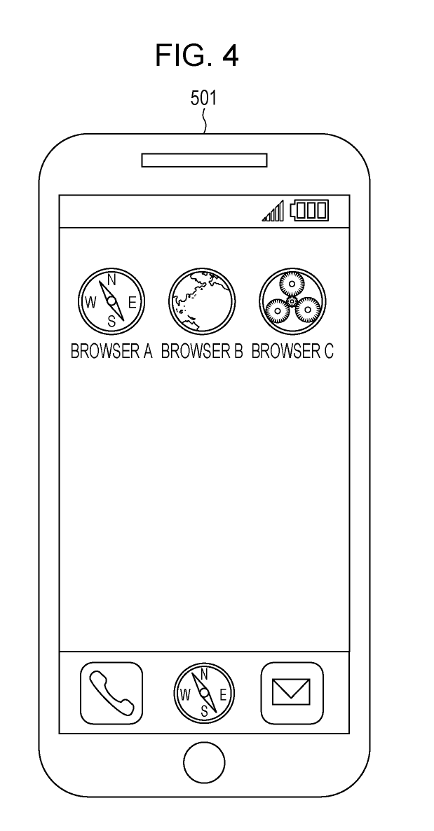

FIG. 4 is a diagram illustrating an example of a UI of an information processing terminal in an embodiment of the present invention.

In FIG. 4, reference numeral 501 denotes an information processing terminal, such as a general mobile terminal or smartphone. The information processing terminal 501 has an operating system (OS) installed, such as an android (a registered trademark), which is a platform developed for mobile information terminals.

In the example of FIG. 4, the information processing terminal 501 has a plurality of Web browsers (a browser A, a browser B, and a browser C) as application programs. These Web browsers each correspond to the UA 106 in FIG. 1, which can use Web Intents. In other words, the information processing terminal 501 has a plurality of relay functions for Web Intents.

Upon detecting a service corresponding to the service 103 in FIG. 1 while using a Web browser, the user registers the service in the Web browser when needed. A list of services that the Web browser manages is for the Web browser. Thus, Web Intents registered in Web browsers differ from one Web browser to another Web browser.

Although this embodiment is described using a smartphone-type information processing terminal, as shown in FIG. 4, there is no limitation to the form of the information processing terminal as a platform, and the present invention can be applied to general computers (for example, a personal computer).

### Hardware Configuration of Client 101 and Service 103

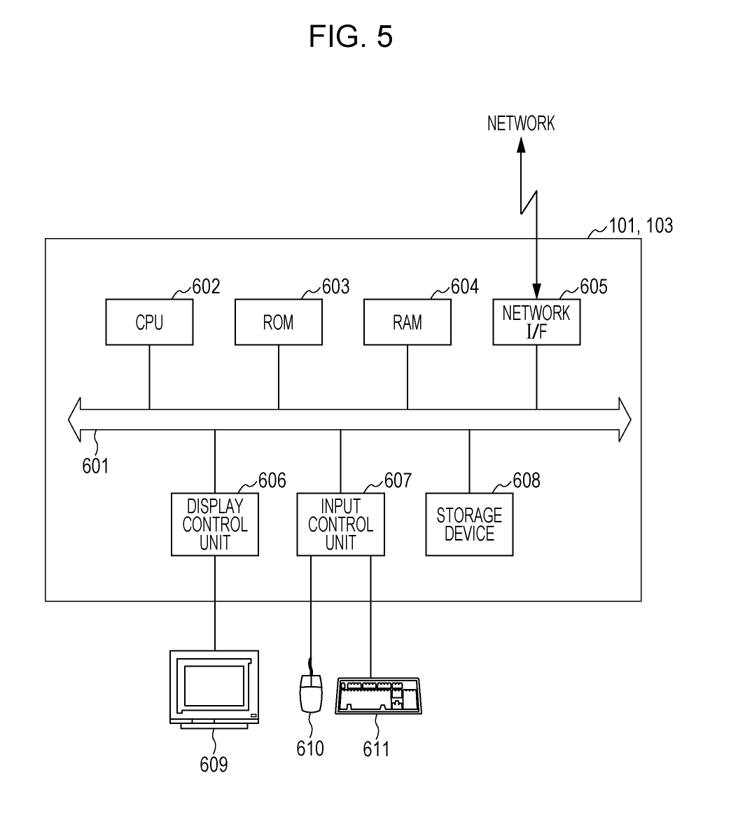

FIG. 5 is a block diagram illustrating an example hardware configuration of the client 101 and the service 103 in FIG. 1.

The client 101 and the service 103 may be general-purpose computers. The client 101 and the service 103 each include a CPU 602, a ROM 603, and a RAM 604. The CPU 602 controls the overall system as a whole by reading and executing programs stored in the ROM 603 or a storage device 608, described later. The ROM 603 is a read-only memory for storing a boot program for starting the system. The RAM 604 is a work memory for executing programs with the CPU 602.

A network interface (network I/F) 605 performs communications over a network. A display control unit 606 controls display of a display device 609. For example, the display control unit 606 controls screen display for managing a Web server. The display device 609 displays an output signal controlled by the display control unit 606 to an operator who is a Web server administrator. An input control unit 607 controls input signals received from input devices 610 and 611. The input device 610 is a pointing device, such as a mouse, and the input device 611 is a keyboard or the like and receives an input from the operator.

The storage device 608 is a nonvolatile storage device that stores programs executed by the CPU 602 and a variety of information, such as a magnetic disk or a flash memory. In the case of the client 101, the storage device 608 also stores content information provided by the client 101. In the case of the service 103, the storage device 608 also stores data and programs for the service 103 to provide functions.

The processes of the client 101 and the service 103 in the embodiment are implemented by the CPUs 602 of the client 101 and the service 103 reading and executing programs stored in the storage devices 608.

### Example of Hardware Configuration of Information Processing Terminal 501

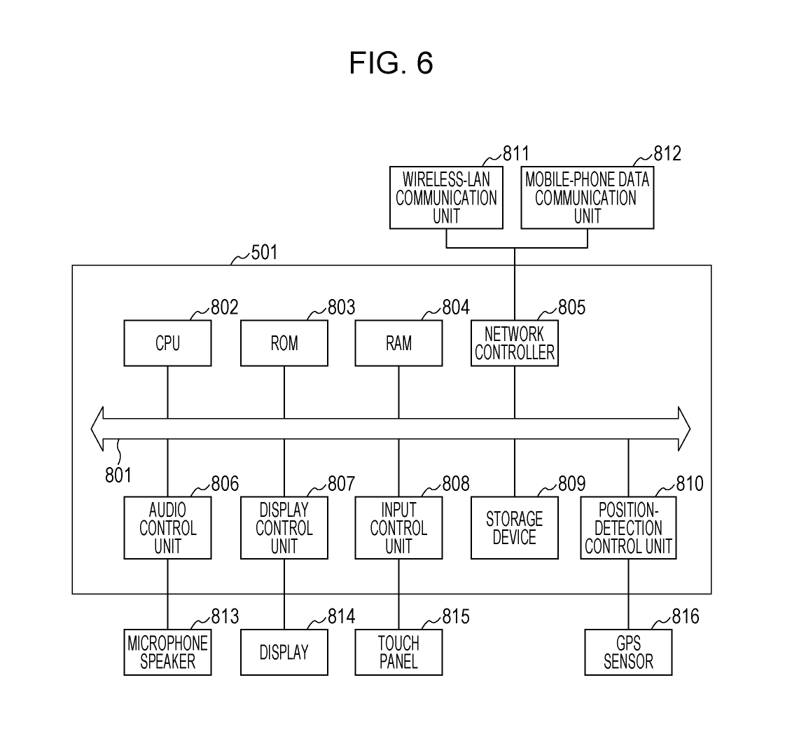

FIG. 6 is a block diagram illustrating the hardware configuration of the information processing terminal 501. The UA 106 shown in FIG. 1 is executed on the hardware. The information processing terminal 501 shown in FIG. 6 is a general mobile terminal or smartphone, on which a compact-terminal operating system and programs that control phone calls and data communications run.

The components of the hardware of the information processing terminal 501 are connected to a system bus 801. A ROM 803 stores the operating system for the information processing terminal 501, applications that control phone calls and data communications, and so on, which are read by the CPU 802 for execution. Examples of the applications that control data communications include mail software and a Web browser.

A RAM 804 is a work memory area for executing programs. The RAM 804 also serves as a memory for temporarily storing Web page data that a Web browser obtained from a Web server and authentication information for accessing Web services. A storage device 809 is a nonvolatile storage device, in which various operation mode settings and an operation log, which are to be stored after the information processing terminal 501 is started again, are stored.

A network controller 805 controls the communications of a wireless LAN communication unit 811 for joining a wireless LAN and a mobile-phone-data communication unit 812 for joining a network that a telephone service provider provides. When the network controller 805 can join a wireless LAN network, the network controller 805 gives priority to wireless LAN connection via the wireless LAN communication unit 811. When the information processing terminal 501 comes out of the network area of the wireless LAN, the network controller 805 via the mobile-phone-data communication unit 812 joins a wireless communication network that a telephone service provider provides.

An audio control unit 806 is used mainly when a phone application is started, and the user is on a call. A microphone speaker 813 is used to input and output audio data. The audio control unit 806 acts as a go-between in connecting to a control program for the microphone speaker 813. A display control unit 807 control output information on a display 814 of the information processing terminal 501. An input control unit 808 controls information that the user designates with a button or a touch panel 815 on the information processing terminal 501. Applications on the information processing terminal 501 provide the user with network communication information and a variety of information on the information processing terminal 501 using the audio control unit 806, the display control unit 807, and the input control unit 808. A position-detection control unit 810 obtains positional information on the information processing terminal 501 from a GPS sensor 816 and provides it to the operating system. The above components are controlled by the operating system running on the CPU 802.

The UA 106 shown in the embodiment is implemented by reading and executing programs stored in the ROM 803 with the CPU 802 of the information processing terminal 501.

### Example of Software Configuration of Information Processing Terminal 501

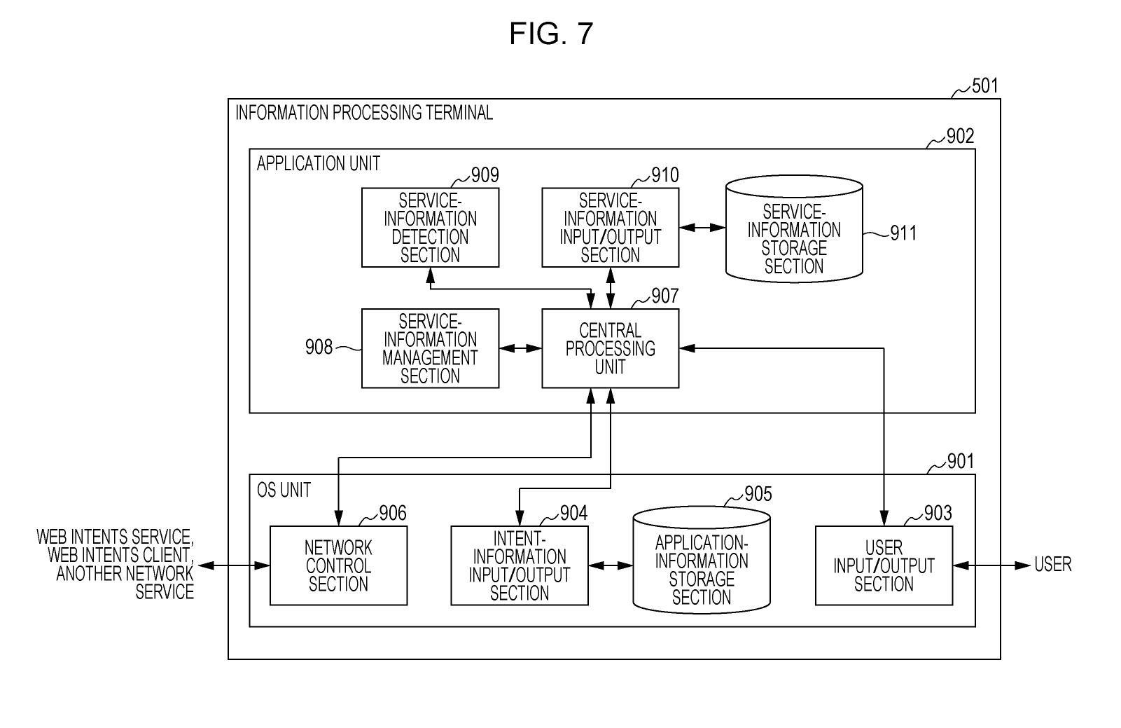

FIG. 7 is a block diagram illustrating the software configuration of the information processing terminal 501 in FIG. 4. FIG. 7 shows a technique for issuing a Web Intents request by an application related to the present invention and a function for mutual usage of functional information using Intent. Intents is a technique for transmitting and receiving data between any applications. This is a technique that can be used on android (a registered trademark), which is a platform developed for mobile information terminals. Although similar techniques are implemented in other platforms, in this embodiment, a technique for transmitting and receiving data between applications in an information processing terminal is referred to as Intent.

In FIG. 7, reference numeral 501 denotes the information processing terminal shown in FIG. 4. In this example, the information processing terminal 501 is a mobile terminal or a smartphone. The information processing terminal 501 generally includes an operating system (hereinafter referred to as an OS) for controlling the system, which is shown as an OS unit 901 in FIG. 7. The information processing terminal 501 can have a plurality of applications installed. These applications are shown as an application unit 902 in FIG. 7. Although FIG. 7 shows only one application unit, the information processing terminal 501 actually has a plurality of applications installed.

In some embodiments, it is assumed that a plurality of applications serving as the UA 106 in FIG. 1 operate on the operating system of the information processing terminal 501. Although in some embodiments a Web browser is taken as an example of the application running as the UA 106, any applications running as the UA 106 may be used. For example, an application, such as spreadsheet software, may provide the function of the UA 106. In some embodiments, an OS may function as the UA 106.

Applications assumed in some embodiments are applications, such as a Web browser, that can control Web Intents as the UA 106 and can transmit and receive data between applications. Another technique for transmitting and receiving data between applications is Web Intents, in addition to Intents. A first embodiment shows an embodiment in which data is transmitted and received between applications using Intent. A second embodiment shows an embodiment in which data is transmitted and received between applications using Web Intents. However, applications assumed here need only to be able to transmit and receive data between any applications and does not need to use Intent or Web Intents.

The OS unit 901 and the application unit 902 shown in FIG. 7 are implemented by reading and executing the OS and application programs stored in the ROM 803 with the CPU 802 of the information processing terminal 501.

First, the OS unit 901 will be described.

In the OS unit 901, reference numeral 906 denotes a network control section. The network control section 906 controls the network controller 805 in FIG. 6. Since the information processing terminal 501 is assumed to be used during moving because it is a compact portable terminal, the network control section 906 automatically connects to an accessible network depending on its location. Furthermore, the network control section 906 connects to an external device in response to a communication request from the application unit 902. The network control section 906 sorts a connection request to an appropriate application unit 902 in response to an external network connection request.

Reference numeral 904 denotes an intent-information input/output section, and 905 denotes an application-information storage section. Upon receiving an Intent request together with information on action and type (hereinafter referred to as data type) from the application unit 902, the OS unit 901 requests an application corresponding to the action and the data type from the intent-information input/output section 904. Upon receiving the Intent request, the intent-information input/output section 904 obtains a list of applications corresponding to the received action and data type from the application-information storage section 905. The intent-information input/output section 904 transmits the obtained application list to the application unit 902.

Reference numeral 903 denotes a user input/output section, which manages the audio control unit 806, the display control unit 807, and the input control unit 808 in FIG. 6 as a whole. When a display instruction is given from the application unit 902 to a user, the user input/output section 903 provides display on the display 814 via the display control unit 807. When the user performs input via the touch panel 815, the user input/output section 903 transmits an input signal controlled by the input control unit 808 to the application unit 902.

Subsequently, the application unit 902 will be described.

The application unit 902 includes a service-information management section 908, a central processing unit 907, a service-information detection section 909, a service-information input/output section 910, and a service-information storage section 911.

The central processing unit 907 plays a key role as a Web browser. The key role of the central processing unit 907 is the UA 106 in Web Intents. In addition, the central processing unit 907 performs a basic browsing process, a process when the service 103 is detected, a control process in using the service 103, and transmission and reception of data via Intent. For example, the central processing unit 907 responds to a request to obtain functional information (functional information for registering functions that the service 103 provides) from another application and issues a request to register functional information to another application using Intent. In the case where Intent in the OS unit 901 is not used, the central processing unit 907 can obtain or provide functional information from/to another application using the service-information management section 908, as shown in a second embodiment described later. Furthermore, the central processing unit 907 responds to a request to obtain functional information from another application using the service-information management section 908 and issues a request to register functional information in another application. The service-information management section 908 will be described later in the second embodiment.

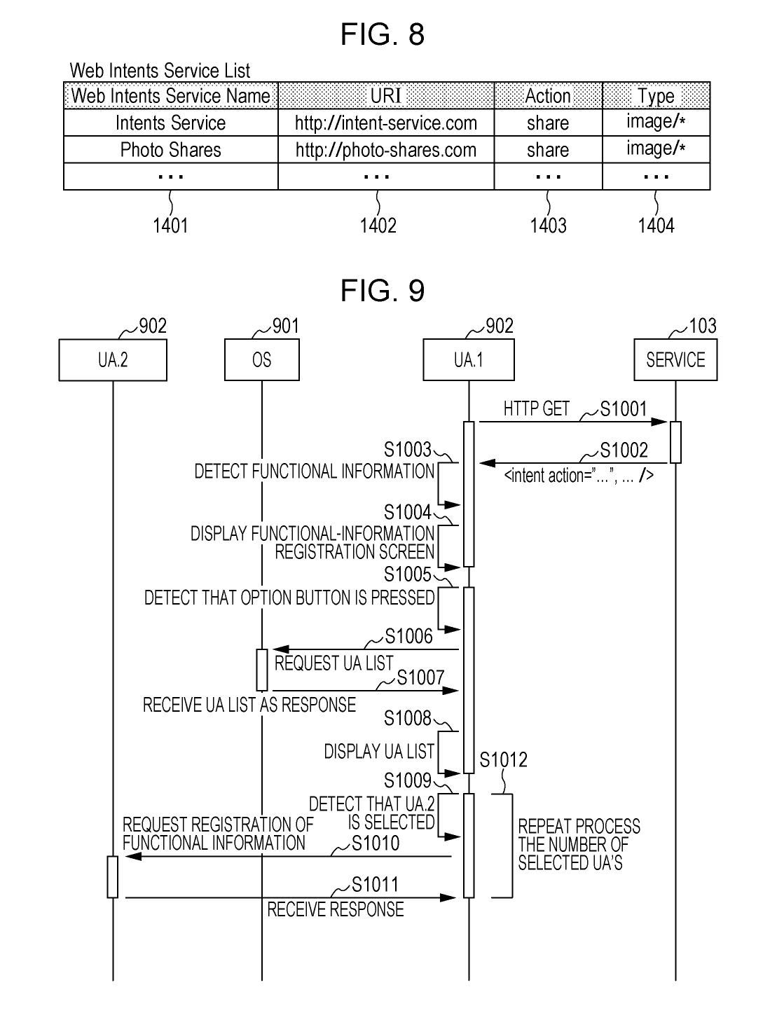

The service-information detection section 909 detects an <intent> tag included in a Web page received from the service 103 upon access and recognizes functional information for registering functions that the service 103 provides. The service-information input/output section 910 controls input/output of functional information to/from the service-information storage section 911. The service-information storage section 911 stores information, as shown in FIG. 8.

FIG. 8 is a diagram illustrating an example of functional information managed by a Web browser serving as a UA.

In the example shown in FIG. 8, information including the name 1401 of a function that the service provides, the destination URI 1402 of the provided function, and an action 1403 and data type 1404 of the Web Intents request is stored in the service-information storage section 911.

The operation of the individual modules of the application unit 902 will be briefly described.

When the user accesses a service (website) that uses a Web Intents system using a Web browser (corresponding to the UA 106), which is an application of the information processing terminal 501, the service-information detection section 909 of the application unit 902 detects an <intent> tag included in a Web page received from the service on access, recognizes functional information (Web Intents service information) for registering a function that the service provides, and notifies the functional information to the central processing unit 907. The central processing unit 907 that has received the notification asks the user whether to register the functional information as Web Intent via the user input/output section 903. If a registration instruction is given by the user, the central processing unit 907 issues an instruction to store the functional information identified by the <intent> tag to the service-information input/output section 910. Upon receiving the instruction to store the functional information, the service-information input/output section 910 stores the functional information in the service-information storage section 911.

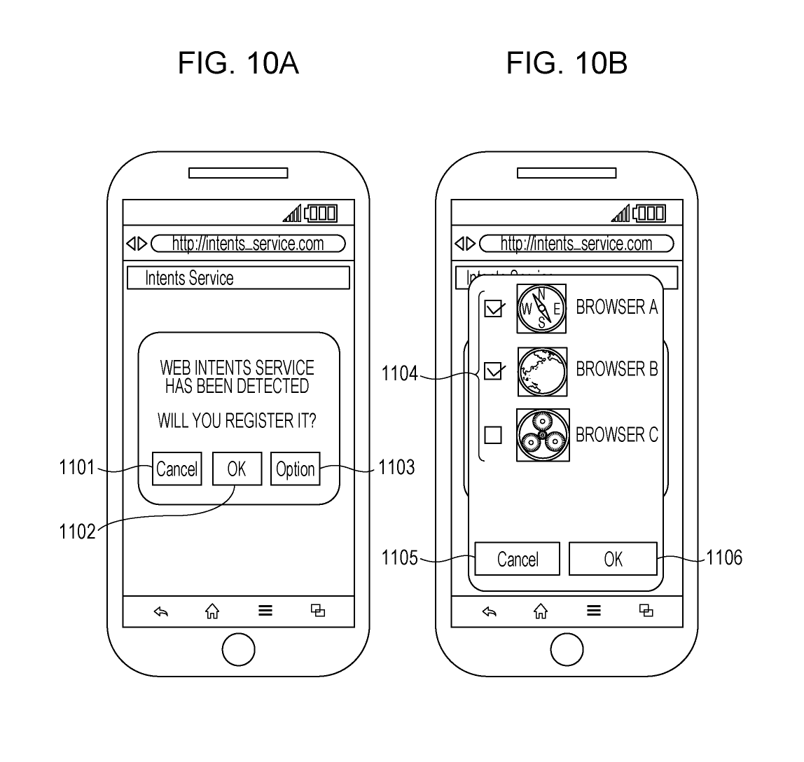

When asking the user whether to register functional information, the information processing terminal 501 asks the user whether to register the functional information also in the information processing terminal 501 or another external application. An example of the screen of the information processing terminal 501 in this example is shown in FIG. 10A. When the user presses an “OK” button 1102 on the screen, the above functional information is registered in the application in operation. When the user presses an “Option” button 1103, applications that are other registration candidates are displayed, and the above functional information is registered in a selected application.

At the information processing terminal 501, upon receiving a registration instruction to another application from the user, the central processing unit 907 issues a request to register the functional information to the application using Intent (in the second embodiment described later, Web Intents). When Intents is used, the central processing unit 907 issues a request to register a list of applications that accept registration of the functional information to the intent-information input/output section 904 of the OS unit 901. The intent-information input/output section 904 that has received the registration request obtains a list of corresponding applications from the application-information storage section 905 and sends it back as a response. The central processing unit 907 that has received the list of applications in which the functional information can be registered using Intent displays the application list via the user input/output section 903. When the user selects a desired application and sends back the application list, the central processing unit 907 issues a request to register the functional information to the selected other application using Intents.

In contrast, upon receiving an instruction to register the functional information from another application using Intent, the central processing unit 907 issues an operation request to the service-information management section 908. If the service-information management section 908 determines that the request is right, the service-information management section 908 registers the functional information in the service-information storage section 911 via the service-information input/output section 910.

When the user requests a process from a service, the central processing unit 907 obtains functional information from the service-information storage section 911 via the service-information input/output section 910. The central processing unit 907 displays a list of the obtained functional information and transmits a Web Intents process request and content information to a service corresponding to functional information selected from the list.

### Example of Sequence Diagram for Mutual Use of Functional Information in First Embodiment

FIG. 9 is a sequence diagram illustrating an example operation in which, when the user of the information processing terminal 501 detects Web Intents using a Web browser, the user requests registration of functional information not only from the Web browser but also from another Web browser. In FIG. 9, the basic sequence of Web Intents described in FIG. 2 is expanded. In FIG. 9, reference numeral 902 denotes a Web browser in the information processing terminal 501. The Web browser serves as a UA in Web Intents. FIG. 9 shows a plurality of UAs, of which a Web browser that detects functional information is User Agent.1 (hereinafter referred to as UA.1), and a Web browser provided with the detected functional information is User Agent.2 (hereinafter referred to as UA.2).

FIGS. 10A and 10B are diagrams illustrating examples of a screen displayed on the Web browser screen of the UA.1.

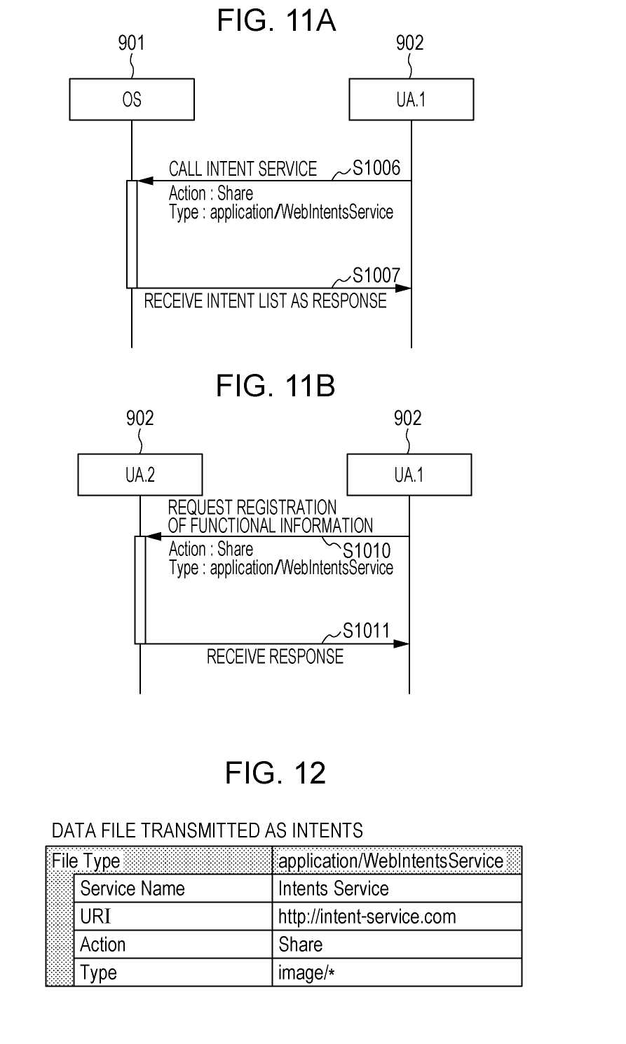

FIGS. 11A and 11B are detailed sequence diagrams of part of the sequence in FIG. 9.

At S1001 in FIG. 9, the UA.1 accesses the service 103 in response to a user instruction. At S1002, the UA.1 receives HTML information including an <intent> tag indicating information indicative of a function that the service 103 provides. At S1003, the service-information detection section 909 of the information processing terminal 501 detects that the website accessed provides the function. Furthermore, the service-information detection section 909 detects that the accessed service 103 is a site that the UA.1 visited for the first time. At S1004, the UA.1 displays a functional-information registration screen as shown in FIG. 10A to ask the user whether to register information on functions that the website provides.

The screen displayed at S1004 displays a “Cancel” button 1101, an “OK” button 1102, and an “Option” button 1103, as shown in FIG. 10A. When the “Cancel” button 1101 is pressed, registration of the functional information can be cancelled. When the “OK” button 1102 is pressed, the functional information can be registered in the website itself. When the “Option” button 1103 is pressed, the functional information can be registered in a plurality of UAs. This sequence diagram describes a process of registering functional information in a plurality of UAs.

At S1005, upon detecting that the “Option” button 1103 is pressed, the UA.1 goes to S1006. At S1006, the UA.1 issues a request to obtain an UA list to the OS unit 901, and at S1007, receives a UA list as a response.

The process from S1006 to S1007 will be described in detail using FIG. 11A.

As shown in FIG. 11A, at S1006, the UA.1 issues a request to obtain a list of applications in which the functional information can be registered using the Intent technique. For example, the UA.1 request “Share” as Action and requests “application/Web Intents Service” as data type. At S1007, the UA.1 receives a list of applications corresponding to the request as an Intent response from the OS unit 901.

Subsequently, at S1008 in FIG. 9, the UA.1 displays a UA list, which is a list of applications that accept registration of the functional information (received at S1007), on a user screen. The Web browser screen of the UA.1 in this example displays a specification screen, as shown in FIG. 10B. The screen shown in FIG. 10B displays a UA list 1104, a “Cancel” button 1105, and an “OK” button 1106. The UA list 1104 may include the UA.1. When the “Cancel” button 1105 is pressed, selection of UAs can be cancelled. If the “OK” button 1106 is pressed in a state in which one or more desired applications (UAs) are selected from the UA list 1104, the selection of the UAs in which the user requests to register functional information can be confirmed.

At S1009, upon detecting that one or more applications (UAs) are selected on the screen in FIG. 10B, the UA.1 goes to S1010. At S1010, the UA.1 issues a request to register the functional information to the selected application (in this example, the UA.2), and at S1011, receives a registration process result as a response.

The process from S1010 to S1011 will be described in detail with reference to FIG. 11B.

As shown in FIG. 11B, at S1010, the UA.1 transmits data (functional information) using the Intent technique. In this example, the UA.1 issues a request to register functional information in which Action is “Share”, and Type is “application/Web Intents Service”. An example of the data file transmitted here has data configuration as shown in FIG. 12. At S1011, the UA.1 receives a registration request process result as a response from the UA.2.

FIG. 12 is a diagram of an example of the data configuration of the functional information transmitted from the UA.1 to the UA.2 at S1010.

As shown in FIG. 12, the data of the functional information includes the name of the provided function, an URI that accepts the provided function, and action and data type of the provided function is provided.

The process of detecting selection of a UA and issuing a request to register functional information to the selected UA, shown at S1009 to S1011 in FIG. 9, is repeated the number of times the user selected a UA (S1012). In this way, the functional information that the UA.1 detected can be registered also as functional information to be managed by other UAs.

### Example of Process Flowchart of UA in First Embodiment

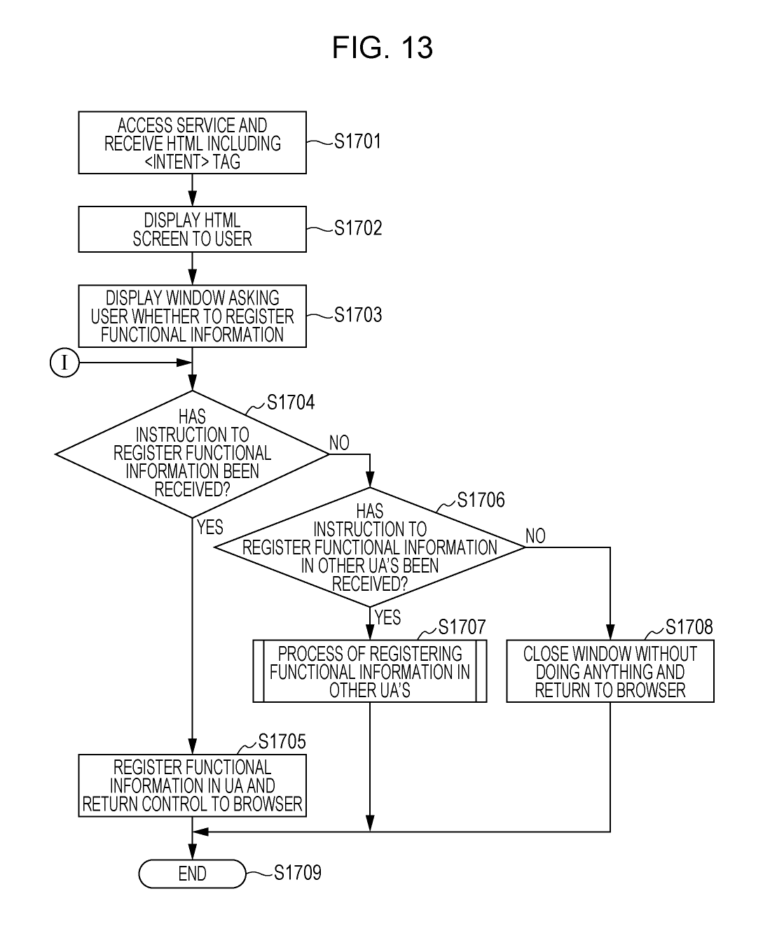

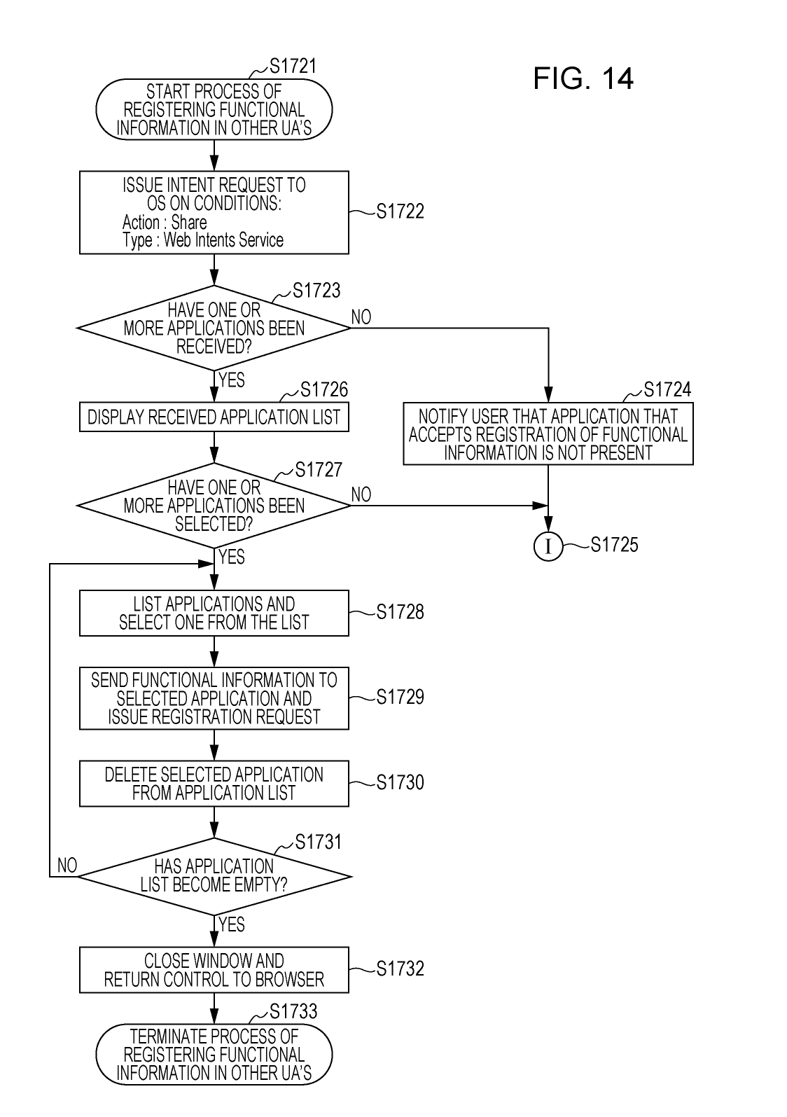

FIG. 13 is a flowchart showing an example of a process after a UA receives HTML including an <intent> tag until functional information is registered in an external application. The processes in the flowchart shown in FIG. 13 and a flowchart shown in FIG. 14, described later, are part of the process performed by the software in the information processing terminal 501 shown in FIG. 7. The processes in the flowcharts are implemented by the CPU 802 of the information processing terminal 501 expanding programs stored in the ROM 803, the storage device 809, and so on in the RAM 804 for execution as appropriate.

At S1701, upon receiving HTML including an <intent> tag from the service 103, the network control section 906 of the information processing terminal 501 goes to S1702. At S1702, the central processing unit 907 forms a Web browser screen from the received HTML information and displays it to the user. Thereafter, the central processing unit 907 goes to S1703.

At S1703, the service-information detection section 909 detects that the HTML received at S1701 includes an <intent> tag and determines that the accessed website provides the function. The central processing unit 907 displays a window asking the user whether to register information on the function that the accessed service provides (for example, FIG. 10A) and goes to S1704.

At S1704, the central processing unit 907 determines whether an instruction to register the functional information is received (whether the “OK” button 1102 in FIG. 10A has been pressed). If it is determined that an instruction to register the functional information is received (Yes at S1704), the central processing unit 907 goes to S1705. At S1705, the central processing unit 907 issues an instruction to register the functional information to the service-information input/output section 910, and upon completion of registration of the functional information in the UA, the central processing unit 907 returns the control to the Web browser. The central processing unit 907 terminates the process (S1709).

In contrast, if it is determined at S1704 that an instruction to register functional information is not received (No at S1704), the central processing unit 907 goes to S1706. At S1706, the central processing unit 907 determines whether an instruction to optionally register the functional information is received (whether the “Option” button 1103 in FIG. 10A has been pressed). If it is determined that an option instruction to register the functional information is received (Yes at S1706), the central processing unit 907 goes to S1707. At S1707, the central processing unit 907 executes a process of registering the functional information to other UAs. The details of S1707 in the first embodiment will be shown later in FIG. 14. Upon completion of the process at S1707, the central processing unit 907 returns the control to the Web browser. The central processing unit 907 terminates the process (S1709).

In contrast, if it is determined at S1706 that an instruction to optionally register the functional information is not received (No at S1706), the central processing unit 907 goes to S1708. Since this corresponds to a case where a cancel instruction is received from the user (the “Cancel” button 1101 in FIG. 10A is pressed), at S1708, the central processing unit 907 closes the registration asking window displayed at S1703 (FIG. 10A) and returns the control to the Web browser. The central processing unit 907 terminates the process (S1709).

### Flowchart of Process of Registering Functional Information to Other UAs

FIG. 14 is a flowchart showing the details of the process of registering functional information to other UAs in the first embodiment (S1707 in FIG. 13).

Upon starting the process of registering functional information to other UAs, shown at S1707 in FIG. 13, (S1721), the central processing unit 907 goes to S1722. At S1722, the central processing unit 907 issues an Intent request in which action is “Share”, and data type is “Web Intents Service” to the OS unit 901 and goes to S1723.

At S1723, the central processing unit 907 determines whether a list of one or more applications has been received from the OS unit 901 as a response to the Intent request. If it is determined that a list of one or more applications has not been received (No at S1723), the central processing unit 907 goes to S1724. At S1724, the central processing unit 907 notifies the user that the central processing unit 907 searched the device for a corresponding application using Intent, but it is not found (for example, displays a message on the screen) and goes to S1725, at which the process is returned to S1704 in FIG. 13.

In contrast, if it is determined that a list of one or more applications has been received (Yes at S1723), the central processing unit 907 goes to S1726. At S1726, the central processing unit 907 displays a screen including the application list obtained at S1723 (for example, FIG. 10B) to the user via the user input/output 903 and goes to S1727.

At S1727, the central processing unit 907 determines whether one or more applications have been selected from the application list displayed at S1726 by the user. An example of the screen in which applications are selected is shown in FIG. 10B. FIG. 10B shows a state in which “browser A” and “browser B” are designated as UAs in which the functional information is to be registered.

If it is determined at S1727 that the “Cancel” button 1105 is pressed, so that no application is selected (No at S1727), the central processing unit 907 goes to S1725 and returns to S1704 in FIG. 13.

In contrast, if it is determined at S1727 that one or more applications are selected, and the “OK” button 1106 is pressed (Yes at S1727), the central processing unit 907 goes to S1728.

At S1728, the central processing unit 907 selects one of the one or more applications selected at S1727 and goes to S1729. At S1729, the central processing unit 907 issues a request to register the functional information in which action is “Share”, and data type is “Web Intents Service” using Intent to the application selected at S1728. The application that has accepted the request registers the functional information and returns a registration result as a response. Although transmission and reception of the data are actually performed via the OS unit 901, it will be simply described here. The central processing unit 907 receives the response to the registration request issued at S1729, and upon completion of a process on the application selected at S1728, at S1730, the central processing unit 907 deletes the application selected at S1728 from the application list and goes to S1731.

At S1731, the central processing unit 907 determines whether the application list received at S1723 has become empty. If it is determined that one or applications are left in the application list (No at S1731), the central processing unit 907 goes to S1728.

In contrast, if it is determined at S1731 that the application list has become empty (Yes at S1731), the central processing unit 907 goes to S1732. At S1732, registration of the functional information in all applications (UAs) that the user desires is completed, and the central processing unit 907 closes the window (FIG. 10B) used in the registration process and returns the control to the Web browser. The central processing unit 907 terminates the process of registering the functional information to other UAs (S1733).

As described above, in the case where a plurality of UAs are present in an identical information processing terminal, the first embodiment allows functional information detected in one UA to be registered in the other UAs using the Intent framework.

### Second Embodiment

The first embodiment shows a configuration for requesting other UAs to register functional information using Intent of an android (a registered trademark) platform. In contrast, a second embodiment shows a configuration for requesting other UAs to register functional information not using Intent but using W3C Web Intents.

The service-information management section 908 of the application unit 902 shown in FIG. 7 has the function of an HTTP client and the function of a Web Intents service. The service-information management section 908 issues a request to register functional information to external applications using the Web Intents framework. Furthermore, upon receiving a request to register functional information together with information on action and data type from an external application using the Web Intents framework, the service-information management section 908 registers the functional information in the service-information storage section 911 via the central processing unit 907 and the service-information input/output section 910.

### Example of Another Sequence Diagram for Mutual Use of Functional Information in Second Embodiment

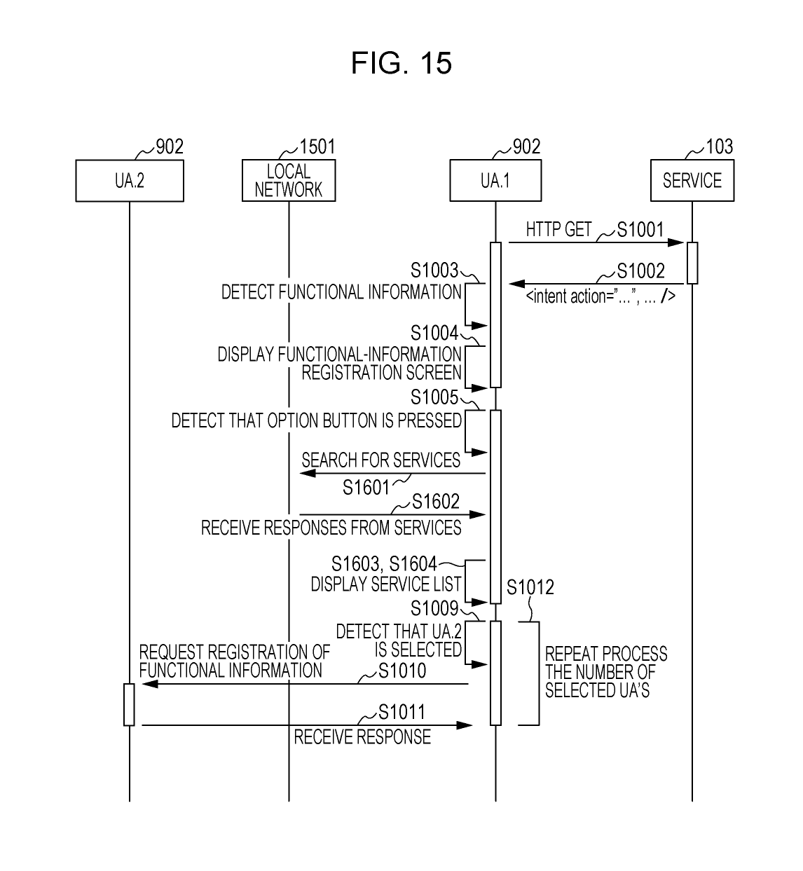

FIG. 15 is a sequence diagram illustrating an example operation in which, when the user of the information processing terminal 501 detects Web Intents using a Web browser, the user requests registration of functional information not only from the Web browser but also from another Web browser. The same steps as those in FIG. 9 are given the same step numbers. Differences from FIG. 9 will be described hereinbelow.

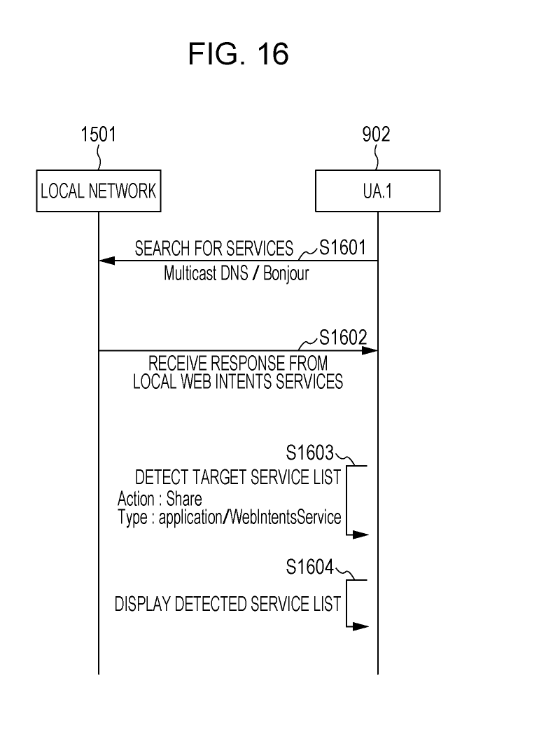

FIG. 16 is a detailed sequence diagram of part of the sequence in FIG. 15.

Since the process from S1001 to S1005 is the same as that in FIG. 9, a description thereof will be omitted. The information processing terminal 501 of the second embodiment searches a local area network (local network) 1501 for applications or services (hereinafter simply referred to as services) that can provide functional information. Specifically, at S1005, upon detecting that the “Option” button 1103 (FIG. 10A) is pressed, the UA.1 searches the local network 1501 for services at S1601. The network search will be described in detail hereinbelow with reference to FIG. 16.

As shown in FIG. 16, at S1601, the UA.1 searches the local network 1501 for services. For example, the UA.1 searches a link local for network services using, for example, Multicast DNS in Bonjour, which is a zero configuration technique of Apple Inc.

At S1602, the UA.1 receives responses from individual services. In the second embodiment, since the UA.1 searches the local network 1501, the UA.1 can receive responses not only from services in the information processing terminal 501 but also from services within the service area of the local network 1501. The area of this network is not limited here.

Subsequently, at S1603, the UA.1 detects services that provide a function in which data type is “application/Web Intents Service”, and action is “Share” from the services that received at S1602 and lists the services. If information for the detection is insufficient, the UA.1 may obtain more information by accessing the services that responded at S1602. Such processes allow the UA.1 to search the local area network for services that can provide functional information.

Subsequently, at S1604, the UA.1 displays a list of the services detected at S1603 to the user and goes to S1009. Since the subsequent processes are the same as those in FIG. 9, descriptions thereof will be omitted.

### Flowchart of Process of Registering Functional Information to Other UAs in Second Embodiment

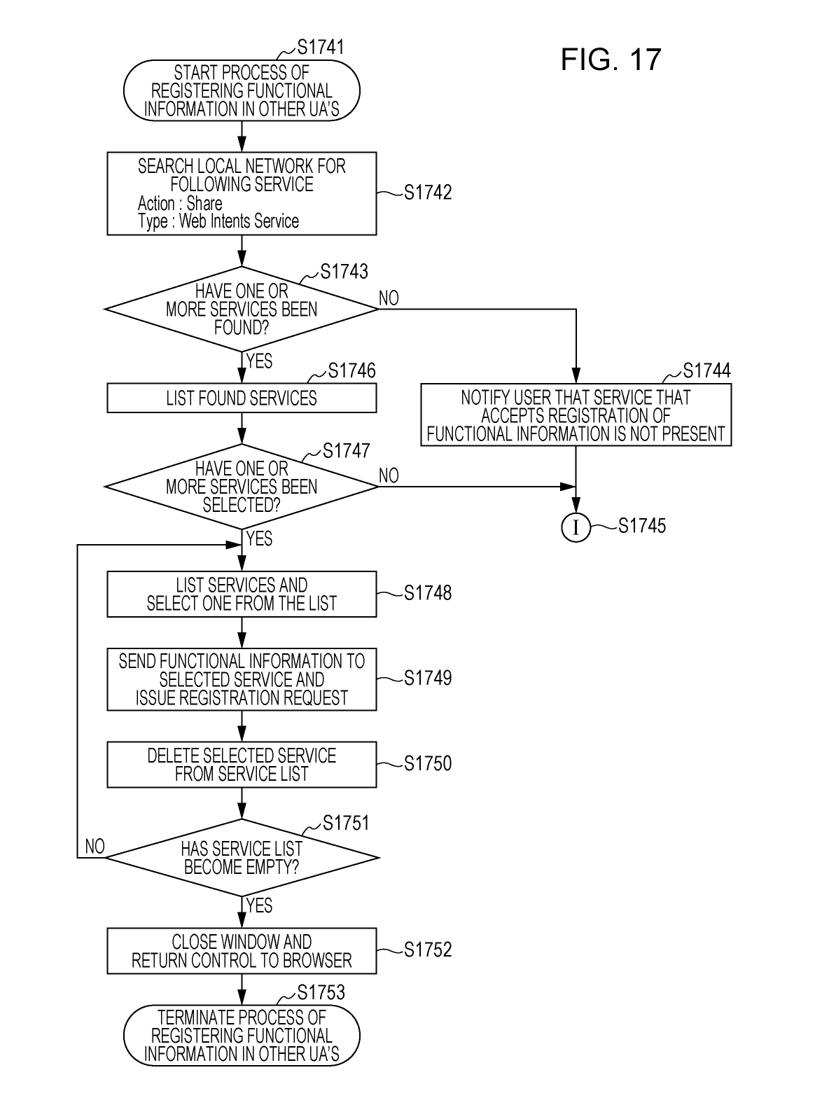

FIG. 17 is a flowchart showing the details of the process of registering functional information to other UAs in the second embodiment (S1707 in FIG. 13). The process in this flowchart is implemented by the CPU 802 of the information processing terminal 501 expanding programs stored in the ROM 803, the storage device 809, and so on into the RAM 804 for execution as appropriate.

Upon starting the process of registering functional information to other UAs, shown at S1707 in FIG. 13 (S1741), the central processing unit 907 goes to S1742. At S1742, the service-information management section 908 searches the local network 1501 for applications or services (hereinafter simply referred to as services) that provide functions using the Web Intents framework (corresponding to S1601 to S1604 in FIGS. 15 and 16). The target of the search is a service in which action is “Share”, and data type is “Web Intents Service”. The search request is issued using a service search protocol, such as multicast DNS used in Apple bonjour.

Subsequently, at S1743, the service-information management section 908 determined whether one or more corresponding services have been found as a result of the search at S1742. If it is determined that one or more corresponding services have not been found (No at S1743), the service-information management section 908 goes to S1744. At S1744, the service-information management section 908 notifies the user via the central processing unit 907 that no corresponding service is present in the network search area (for example, displays a message on the screen) as a search result and goes to S1745 and returns to S1704 in FIG. 13.

In contrast, if it is determined that a list of one or more services has been received (Yes at S1743), the service-information management section 908 goes to S1746. At S1746, the central processing unit 907 displays a screen including the service list obtained at S1743 (for example, see FIG. 10B) via the user input/output section 903 and goes to S1747.

At S1747, the central processing unit 907 detects whether one or more services have been selected from the service list displayed at S1746 (for example, 1104 in FIG. 10B) by the user. An example of the screen in which services are selected is shown in FIG. 10B. FIG. 10B shows a state in which “browser A” and “browser B” are designated as UAs in which functional information is to be registered.

If it is determined at S1747 that the “Cancel” button 1105 is pressed, so that no service is selected (No at S1747), the central processing unit 907 goes to S1745 and returns to S1704 in FIG. 13.

In contrast, if it is determined at S1747 that one or more services have been selected, and the “OK” button 1106 has been pressed (Yes at S1747), the central processing unit 907 goes to S1748.

At S1748, the service-information management section 908 selects one from the one or more services selected at S1746 and goes to S1749. At S1749, the service-information management section 908 issues a request to register functional information in which action is “Share”, and data type is “Web Intents Service” using Web Intents to the service selected at S1748. The service that has received this request registers the functional information and sends back a registration result as a response. The service-information management section 908 receives the response to the registration request issued at S1749, and upon completion of a process on the service selected at S1748, the service-information management section 908 deletes at S1750 the service selected at S1748 from the service list and goes to S1751.

At S1751, the service-information management section 908 determines whether the service list received at S1723 has become empty. If it is determined that one or more services remain in the service list (No at S1751), the service-information management section 908 returns to S1748.

If it is determined at S1751 that the service list has become empty (Yes at S1751), the service-information management section 908 goes to S1752. At S1752, registration of the functional information in all services (UAs) that the user desires is completed, and the service-information management section 908 closes the window used in the registration process (FIG. 10B) via the central processing unit 907 and returns the control to the Web browser. The central processing unit 907 terminates the process of registering the functional information to other UAs (S1753).

As described above, in the case where a plurality of UAs are present in an identical information processing terminal, the second embodiment allows functional information detected in one UA to be registered in the other UAs using the Web Intent framework.

### Third Embodiment

In the first and second embodiments, configurations for implementing mutual use of functional information by registering the functional information in an application and also the other applications. To share functional information, the first embodiment uses Intent, and the second embodiment uses Web Intents.

However, some users may find the operation of selecting a target application every time functional information is found and issuing a request to register the functional information to the individual applications troublesome. The user is only to register found functional information in one of applications in use and to import/share the functional information from/with the application at a desired time. A third embodiment shows a configuration for obtaining functional information from one or more other applications when one application is in use and providing functional information that has not been registered in other applications will be described.

### Example of Sequence Diagram for Mutual Use of Functional Information in Third Embodiment

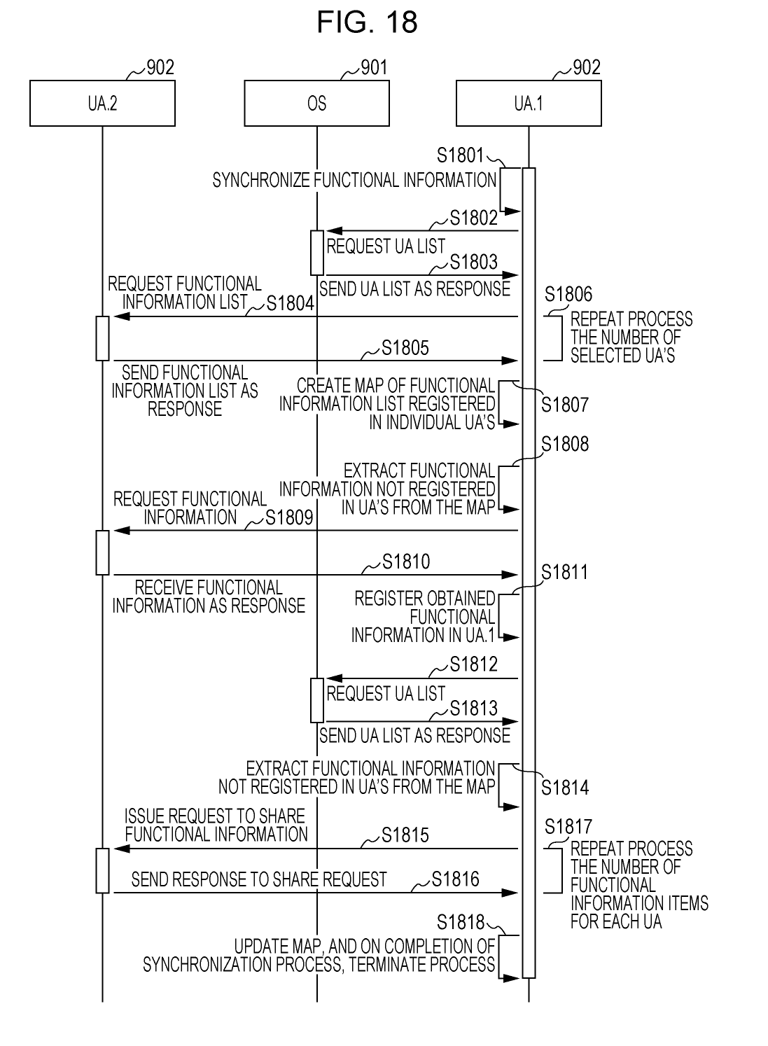

FIG. 18 is a sequence diagram of a process in which the user of the information processing terminal 501 synchronizes registered functional information between a Web browser and other Web browsers. This diagram illustrates an operation example in which the user of the information process terminal 501 obtains, using one Web browser, functional information registered in other one or more Web browsers, provides the obtained functional information to other Web browsers in which the functional information has not yet been registered, and issues a registration request thereto. In FIG. 18, the basic sequence of Web Intents described in FIG. 2 is expanded. In FIG. 18, reference numeral 902 denotes a Web browser in the information processing terminal 501. The Web browser serves as a UA in Web Intents. FIG. 18 shows a plurality of UAs, of which a Web browser that issues requests to collect and provide functional information is UA.1, and a Web browser that provides an Intent service (in a fourth embodiment described later, a Web Intents service), provides functional information in response to a request, and receives a registration request is UA.2. Although a plurality of browsers UA.2 are actually present, one UA.2 is shown for illustrative purpose.

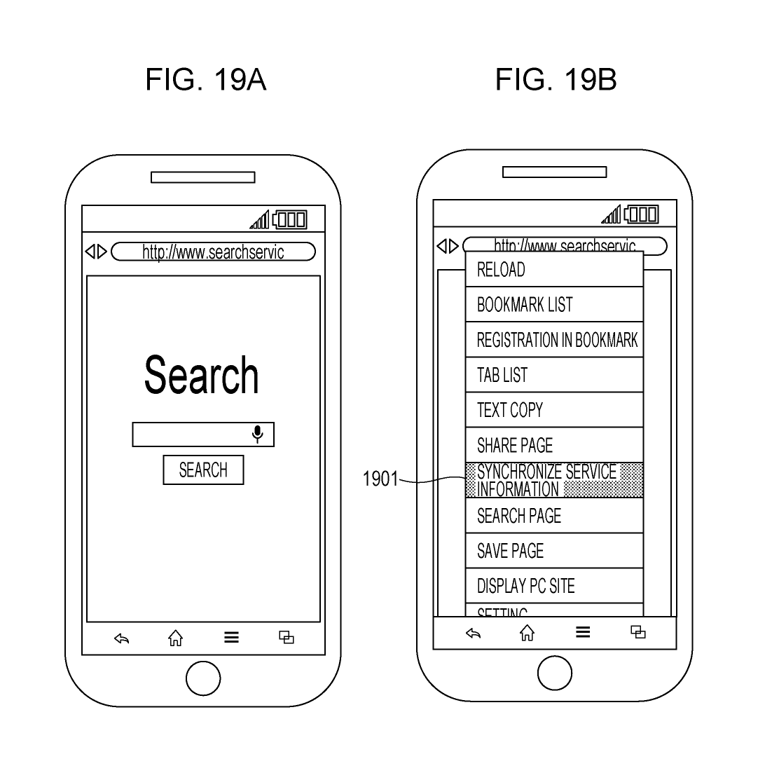

FIGS. 19A and 19B are diagrams showing examples of the Web browser screen of the UA.1.

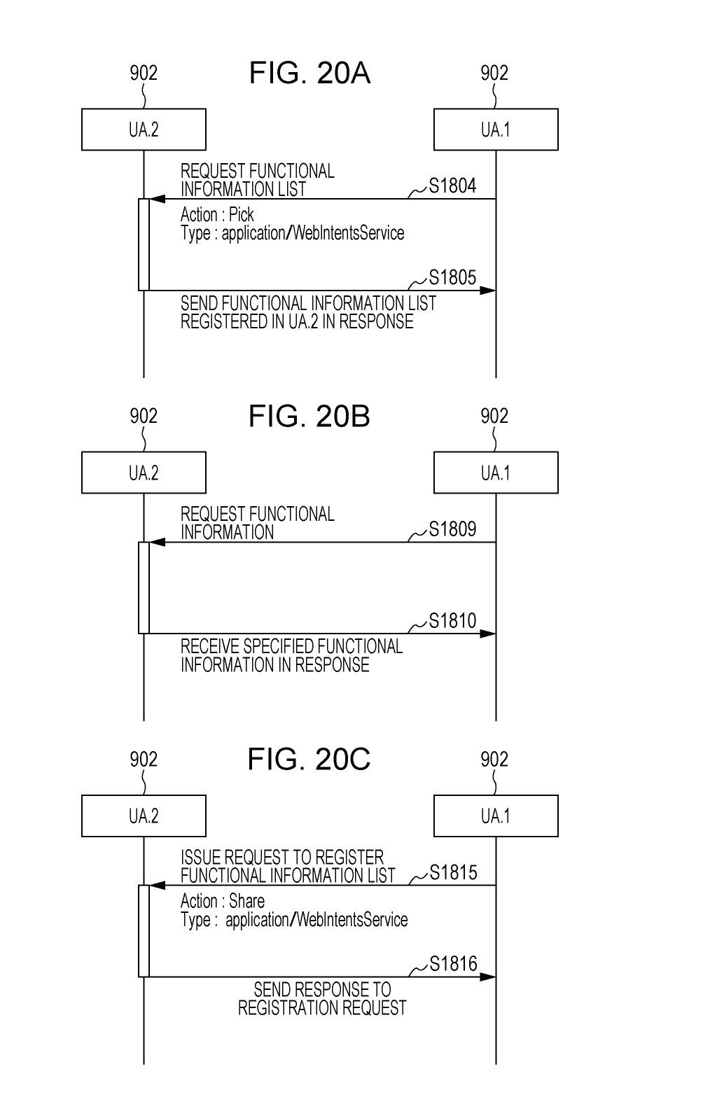

FIGS. 20A to 20C are detailed sequence diagrams of part of the sequence in FIG. 18.

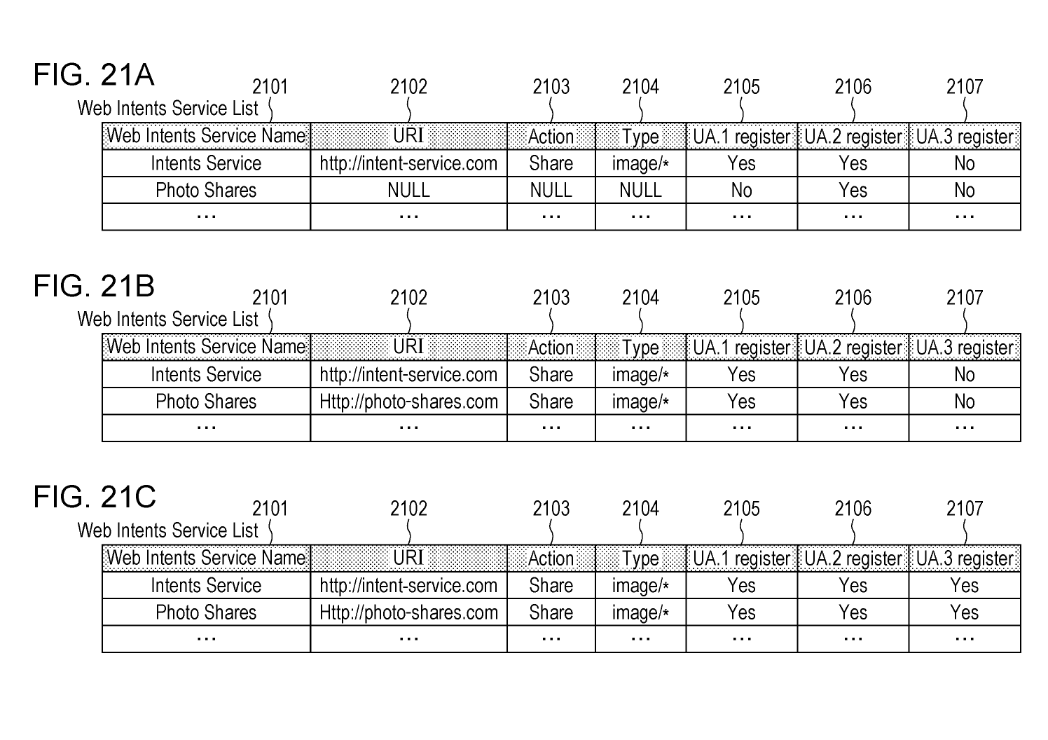

FIGS. 21A to 21C are diagrams illustrating maps of functional information registered in UAs.

At S1801 in FIG. 18, the user issues an instruction to import and share functional information using the UA.1. Examples of the screen of the information processing terminal 501 are shown in FIGS. 19A and 19B. When the user launches the Web browser, a home screen set in the application is displayed. Assume that the user sets some search site, and a screen as shown in FIG. 19A is displayed. The user displays a Web browser menu, as shown in FIG. 19B, and presses a “service information import/share” menu 1901 (“synchronize service information” in FIG. 19B) in the Web browser menu. Upon detecting that the “service information import/share” menu 1901 is pressed, the UA.1 determines that an instruction to synchronize the functional information is given and goes to S1802.

At S1802, the UA.1 requests the OS unit 901 to obtain a list of applications that provide the functional information using Intent. In response to the request, at S1803, the OS unit 901 obtains a list of applications that can provide the functional information from the application-information storage section 905 via the intent-information input/output section 904 and sends it back as a response. Upon receiving the response (the application list), the UA.1 goes to S1804.

At S1804, the UA.1 issues a request to obtain a list of functional information to one of the applications obtained at S1803 (in this example, the UA.2). In response to the request, at S1805, the UA.2 sends back a list of functional information that the UA.2 manages. The UA.1 receives the response (the functional information list).

The process from S1804 to S1805 will now be described in detail with reference to FIG. 20A.

As shown in FIG. 20A, at S1804, the UA.1 issues a request to obtain functional information from other applications using the Intent technique. For example, the UA.1 requests “Pick” as action and “application/Web Intents Service” as data type. At S1805, a list of functional information registered in the UA.2 is returned to the UA.1 as a response to the Intent request issued at S1804.

As shown at S1806 in FIG. 18, the UA.1 repeats the process from S1804 to S1805 by the number of applications obtained at S1803 and goes to S1807.

At S1807, the UA.1 creates a map on the basis of the functional information lists collected from the UAs at S1806. This map shows list information on the functional information registered in the individual UAs.

An example of the map created at S1807 is shown in FIG. 21A.

As shown in FIG. 21A, four columns from the left (2101 to 2104) show the functional information obtained from the individual UAs, in which all items of functional information are registered uniquely record by record. This example shows the name 2101 of a provided function corresponding to functional information, the destination URI 2102 of the provided function, and an action (Action) 2103 and data type (Type) 2104 in the Web Intents request. The fifth column from the left and thereafter (2105 to 2107) are variable, which correspond to the number of applications (UAs) and indicates whether functional information corresponding to their records is registered in the UAs. The map created at S1807 in FIG. 18 shows an initial registration state indicating whether functional information is registered in the individual UAs. If functional information is registered, it is marked with “Yes”, and if not registered, it is marked with “No”.

At S1808, the UA.1 extracts functional information that is not registered in the UA.1 using the map and determines an application in which the functional information is registered. At S1809, the UA.1 issues a request to obtain functional information to the application in which the functional information that is not registered in the UA.1 is registered (in this example, the UA.2) using Intent. At S1810, the UA.2 returns a response to the acquisition request issued at S1809, and the UA.1 receives the response.

The process from S1808 to S1809 will be described in detail with reference to FIG. 20B.

As shown in FIG. 20B, at S1809, the UA.1 issues an Intent request in which action is “Pick” and data type is “Web Intents Service”. In this example, the UA.1 issues a request indicating specific functional information (functional information that is not registered in UA.1 described above) to the UA.2. At S1810, the UA.1 receives the designated functional information as a response to the Intent request issued at S1809. If there are a plurality of items of functional information that are not registered in the UA.1, and they are managed by different applications, the process from S1809 to S1810 is repeated until all items of the functional information that is not registered in the UA.1 are registered.

Subsequently, at S1811 in FIG. 18, the UA.1 registers the functional information obtained at S1810 as functional information to be managed by the UA.1 and updates the map information created at S1807. The state of the updated map is shown in FIG. 21B. In FIG. 21B, the functional information of “Photo Shares”, which is not managed by the UA.1 in the second record, is updated so that URI 2102, action 2103, and data type 2104 are added, and the registration state 2105 of UA.1 is updated to “Yes”.

Subsequently, at S1812, the UA.1 requests the OS unit 901 to obtain a list of applications that accept registration of the functional information using Intent. In response to the request, at S1813, the OS unit 901 obtains a list of applications that can accept registration of the functional information from the application-information storage section 905 via the intent-information input/output section 904 and sends back a response. Upon receiving the response (the application list), the UA.1 goes to S1814.

At S1814, the UA.1 extracts a list of functional information that is not registered in the obtained acquisition list. In the example shown in FIG. 21B, the UA.1 extracts a list of functional information corresponding to a record corresponding to “No” in the column of UA.3 register 2107 (“Intents Service” and “Photo Shares”).

Subsequently, at S1815, the UA.1 issues a request to register a functional information list to one of the applications in the list (in this example, the UA.2). In response to the request, at S1816, the UA.2 registers the functional information and sends back a registration result. The UA.1 receives the response.

The process from S1815 to S1816 will be described in detail with reference to FIG. 20C.

As shown in FIG. 20C, at S1815, the UA.1 issues an Intent request to register action “Share” and data type “Web Intents Service” together with specific functional information (functional information that is not registered in the target application) to the target application (in this example, the UA.2). At S1816, a registration result is returned to the UA.1 as a response to the Intent request issued at S1815.

As shown at S1817 in FIG. 18, the UA.1 repeats the process from S1815 to S1816 by the number of items of functional information extracted at S1814 for each of the applications obtained at S1813 and goes to S1818.

At S1818, the UA.1 updates the map and completes the synchronization process. The state of the map at that time is shown in FIG. 21C, in which integration of functional information is completed.

### Example of Process Flowchart of UA in Third Embodiment

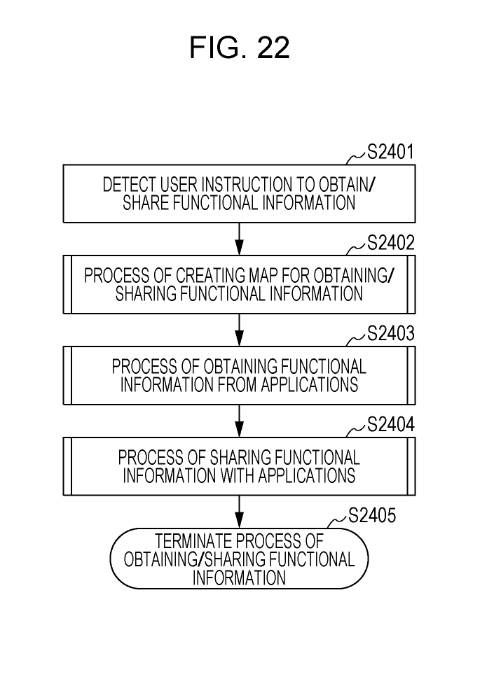

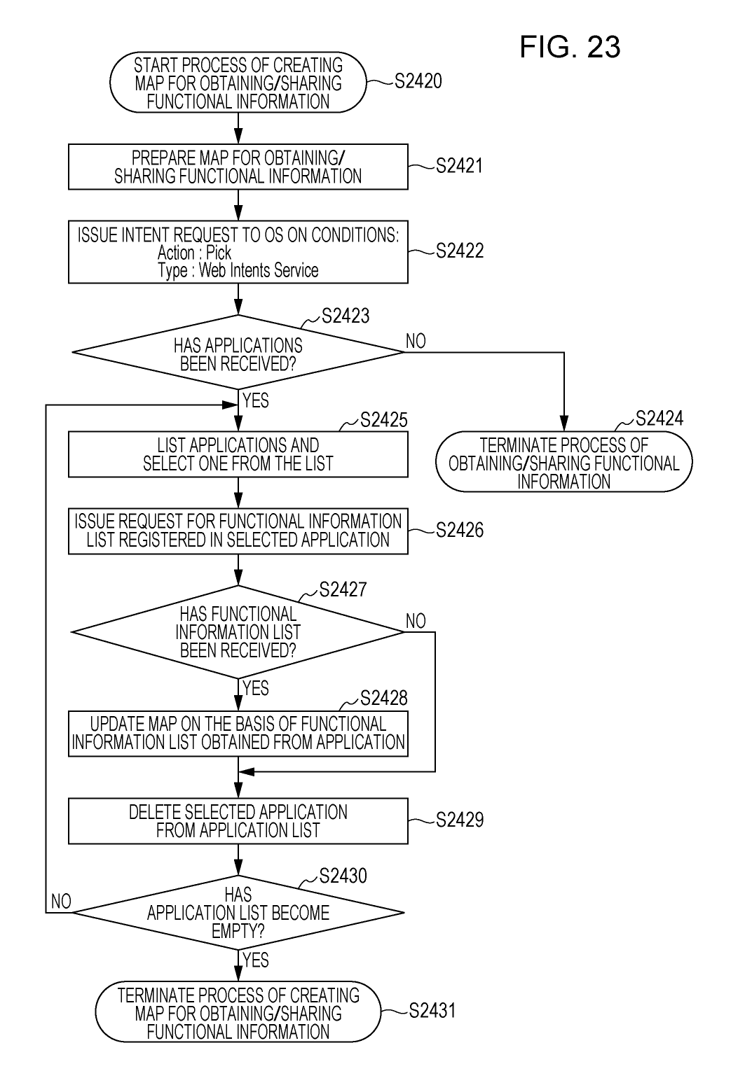

FIG. 22 is a flowchart showing a process after a UA receives an instruction to “import/share service information” from the user until a process of importing/sharing functional information ends. The processes in the flowchart in FIG. 22 and flowcharts in FIG. 23 to FIGS. 25A and 25B, described later, are part of the process performed by the software in the information processing terminal 501 shown in FIG. 7. The processes in the flowcharts are implemented by the CPU 802 of the information processing terminal 501 expanding programs stored in the ROM 803, the storage device 809, and so on in the RAM 804 for execution as appropriate.

The flowchart in FIG. 22 shows roughly divided three parts.

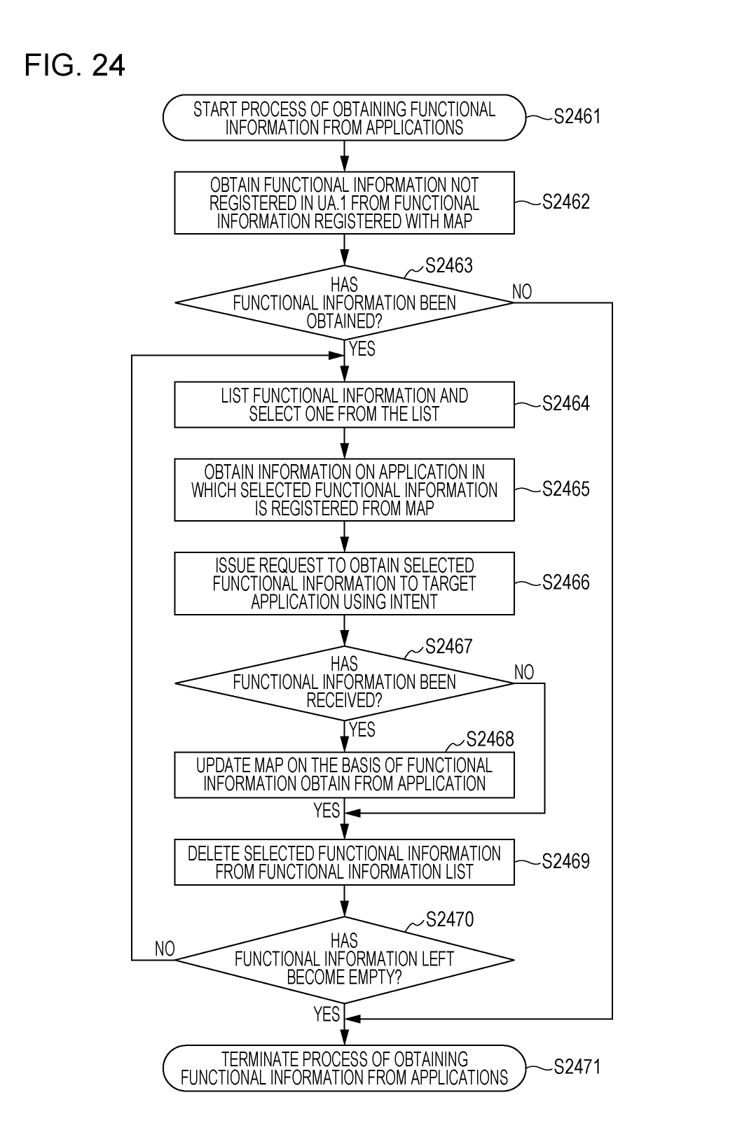

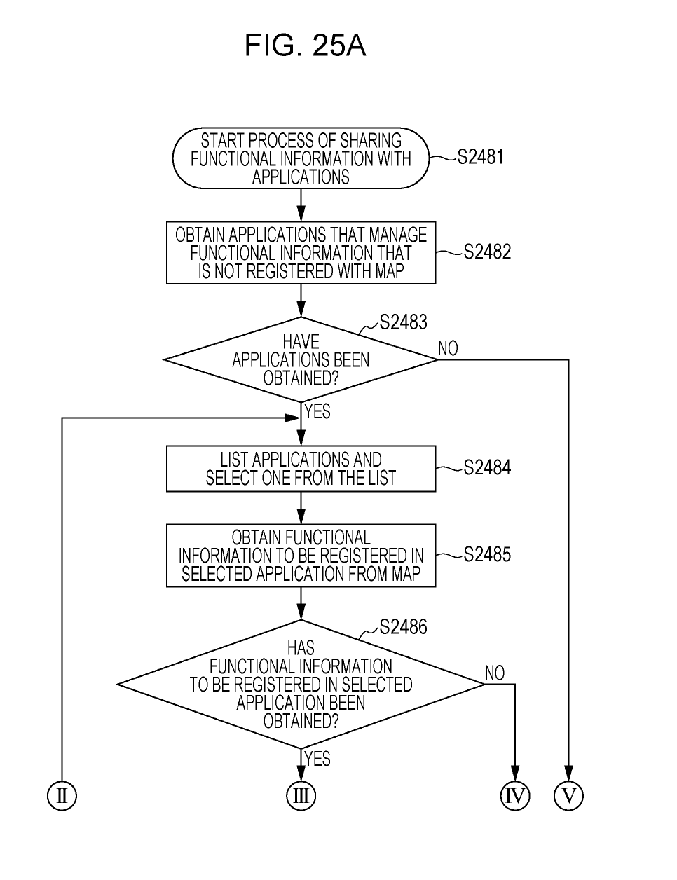

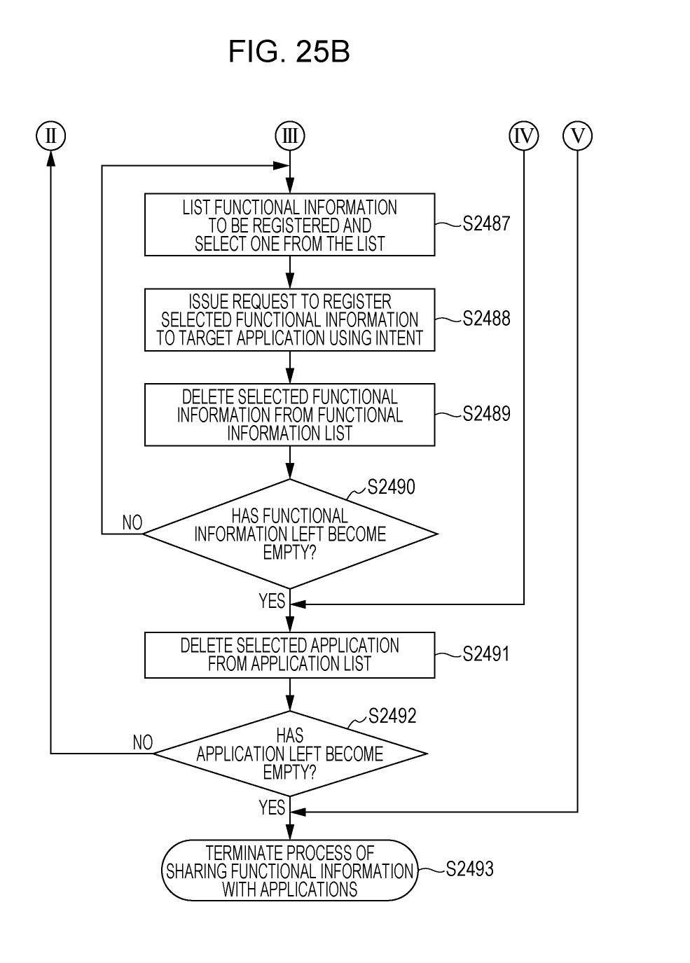

First, at S2401, upon detecting that the “service information import/share” menu 1901 is pressed by the user, the UA.1 determines that an instruction to import/share functional information is given by the user and performs “a process of creating map for obtaining/sharing functional information” at S2402 (the details of which is shown in FIG. 23). Subsequently, the UA.1 performs “a process of obtaining functional information from applications” at S2403 (the details of which is shown in FIG. 24). Subsequently, the UA.1 performs “a process of sharing functional information with applications” at S2404 (the details of which are shown in FIGS. 25A and 25B). At S2405, the UA.1 terminates the process of obtaining/sharing functional information.

The processes at S2402, S2403, and S2404 will be described with reference to the detailed flowcharts.

### Example of Flowchart for Process of Creating Map for Obtaining/Sharing Functional Information

FIG. 23 is a flowchart illustrating the details of the process of creating a map for obtaining/sharing functional information at S2402 in FIG. 22.

At S2420, upon starting the process, the central processing unit 907 of the UA.1 goes to S2421. At S2421, the central processing unit 907 creates a map table for collecting and integrally managing functional information managed by individual applications installed in the information processing terminal 501. The map describes functional information and information registered in the UAs, as shown in FIG. 21A. Upon completion of preparation by initializing the map, the central processing unit 907 goes to S2422.

At S2422, the central processing unit 907 issues an Intent request in which action is “Pick”, and data type is “Web Intents Service” to the OS unit 901 and goes to S2423. At S2423, the central processing unit 907 determines whether information on one or more applications has been received from the OS unit 901 in response to the Intent request.

If it is determined that information on one or more applications has not been received from the OS unit 901 (No at S2423). the central processing unit 907 goes to S2424. This is a case where a corresponding application is searched for using Intent, but it is determined that there is no corresponding application in the information processing terminal 501. This means an environment in which an application for obtaining/sharing functional information is not installed in the information processing terminal 501. Accordingly, at S2424, the central processing unit 907 notifies the user that functional information cannot be obtained/shared (for example, displays a message on the screen) and terminates the process of obtaining/sharing functional information (S2424).

In contrast, if it is determined at S2423 that information on one or more applications is received from the OS unit 901 (Yes at S2423), the central processing unit 907 goes to S2425. At S2425, the central processing unit 907 lists the information on the applications obtained (which is not performed for the second and later rounds), selects any one application, and goes to S2426.

At S2426, the central processing unit 907 issues a request to obtain a functional information list for action “Pick” and data type “Web Intents Service” using Intent to the application selected at S2425. The central processing unit 907 then goes to S2427. At S2427, the central processing unit 907 determines whether a functional information list has been received from the application to which the acquisition request is issued at S2426.

If it is determined that no functional information list could not be received (No at S2427), the central processing unit 907 goes to S2429. In contrast, if it is determined that a functional information list could be received (Yes at S2427), the central processing unit 907 goes to S2428. At S2428, the central processing unit 907 performs a process of updating the map, with the application selected at S2425 and the functional information list obtained from the association associated with each other. Upon completion of the updating process, the central processing unit 907 goes to S2429.

At S2429, the central processing unit 907 deletes the application selected at S2425 from the application list and goes to S2430. At S2430, the central processing unit 907 determines whether the application list has become empty. If it is determined that an application remains in the application list (No at S2430), the central processing unit 907 returns to S2425.

In contrast, if it is determined at S2430 that no application remains in the application list (Yes at S2430), the central processing unit 907 terminates the process of creating a map for obtaining/sharing functional information (S2431) and goes to S2403 in FIG. 22.

Subsequently, S2403 in FIG. 22 will be described with reference to FIG. 24.

Example of Process of Obtaining Functional Information from Applications

FIG. 24 is a flowchart showing the details of the process of obtaining functional information from applications at S2403 in FIG. 22.

Upon starting the process at S2461, the central processing unit 907 of the UA.1 goes to S2462. At S2462, the central processing unit 907 obtains functional information that is not registered in the UA.1 (in this example, name) among functional information registered in the map (the map created at S2402 in FIG. 22) and goes to S2463. At S2463, the central processing unit 907 determines whether one or more items of functional information could be obtained at S2462.

If it is determined that one or more items of functional information could not be obtained (No at S2463), the central processing unit 907 goes to S2471. This is a case where all items of functional information registered in the UAs in the information processing terminal 501 are managed by the UA.1. Accordingly, at S2471, the central processing unit 907 terminates the process of obtaining functional information from applications (S2471).

In contrast, if it is determined at S2463 the one or more items of functional information have been obtained (Yes at S2463), the central processing unit 907 goes to S2464. At S2464, the central processing unit 907 lists the functional information (names) obtained at S2462 (which is not performed for the second and later rounds) and selects any one item of functional information. The central processing unit 907 then goes to S2465.

At S2465, the central processing unit 907 obtains information on an application that manages the functional information selected at S2464 and goes to S2466. At S2466, the central processing unit 907 issues a request to obtain functional information for action “Pick” and data type “Web Intents Service” using Intent to the application obtained at S2465. The central processing unit 907 then goes to S2467.

At S2467, the central processing unit 907 determines whether functional information has been received as a response to the acquisition request issued at S2466. If it is determined that functional information could not be received (No at S2467), the central processing unit 907 goes to S2469.

In contrast, if it is determined at S2467 that functional information has been received (Yes at S2467), the central processing unit 907 goes to S2468. At S2468, the central processing unit 907 update the information of the map using the functional information obtained at S2467 and goes to S2469. The central processing unit 907 registers the functional information obtained at S2467 in the service-information storage section 911 via the service-information input/output section 910.

At S2469, the central processing unit 907 deletes the functional information selected at S2464 from the functional information list obtained at S2463 and goes to S2470. At S2470, the central processing unit 907 determines whether functional information remains in the functional information list created at S2464. If it is determined that functional information remains in the list (No at S2470), the central processing unit 907 returns to S2464.

In contrast, if it is determined at S2470 that no functional information remains in the list (Yes at S2470), the central processing unit 907 terminates the process of obtaining functional information from applications (S2471) and goes to S2404 in FIG. 22.

Subsequently, S2404 in FIG. 22 will be described with reference to FIGS. 25A and 25B.

Flowchart of Process of Sharing Functional Information with Applications

FIGS. 25A and 25B show a flowchart illustrating the details of the process of sharing functional information with applications at S2404 in FIG. 22.

At S2481, the central processing unit 907 of the UA.1 starts the process and goes to S2482. At S2482, the central processing unit 907 obtains applications that manage functional information that is not registered with the map updated at S2403 in FIG. 22 from the map and goes to S2483.

At S2483, the central processing unit 907 determines whether one or more applications have been obtained from the map. If it is determined that one or more applications could not be obtained (No at S2483), the central processing unit 907 terminates the process of sharing functional information with applications (S2493). This is a case where all items of functional information registered in the information processing terminal 501 are shared by all the applications. Thus, the process is terminated.

In contrast, if it is determined at S2483 that one or more applications have been obtained (Yes at S2483), the central processing unit 907 goes to S2484. At S2484, the central processing unit 907 lists information on the one or more applications obtained at S2483 (which is not performed for the second and later rounds), selects any one application from the list, and goes to S2485.

At S2485, the central processing unit 907 obtains information (name) of functional information to be registered in the application selected at S2484 from the map and goes to S2486. At S2486, the central processing unit 907 determines whether information of one or more items of functional information could be obtained at S2485. If it is determined that information of one or more items of functional information could not be obtained (No at S2486), the central processing unit 907 goes to S2491.

In contrast, if it is determined at S2486 that information of one or more items of functional information could be obtained (S2486), the central processing unit 907 goes to S2487. At S2487, the central processing unit 907 lists the information of functional information to be registered in the application selected at S2484 (obtained at S2485) (which is not performed for the second and later rounds), selects any one item of functional information from the list, and goes to S2488.

At S2488, the central processing unit 907 issues a request to register the functional information (selected at S2487) in which action is “Pick” and data type is “Web Intents Service”) using Intent to the application selected at S2484. Thus, the functional information selected at S2487 is registered in the application selected at S2484. The central processing unit 907 then goes to S2489.

At S2489, the central processing unit 907 deletes the functional information selected at S2487 from the functional information list and goes to S2490. At S2490, the central processing unit 907 determines whether the functional information list has become empty. If it is determined that functional information remains in the functional information list (No at S2490), the central processing unit 907 returns to S2487.

In contrast, if it is determined at S2490 that no functional information remains in the functional information list (Yes at S2490), the central processing unit 907 goes to S2491. At S2491, the central processing unit 907 deletes the application selected at S2484 from the application list created at S2484 and goes to S2492. At S2492, the central processing unit 907 determines whether an application remains in the application list created at S2484. If it is determined that an application remains in the application list (No at S2492), the central processing unit 907 returns to S2484.

In contrast, if it is determined at S2492 that no application remains in the application list (Yes at S2492), the central processing unit 907 terminates the process of sharing functional information with applications (S2493) and goes to S2405 in FIG. 22. At S2405 in FIG. 22, the central processing unit 907 terminates the process of obtaining/sharing functional information.

As described above, in the case where a plurality of UAs are present in an identical information processing terminal, the third embodiment allows the user, by issuing an instruction from a UA at desired timing using Intent, to obtain functional information that is not registered in the UA from another one or more UAs and register it, and to provide functional information that is not registered in the other UAs to the other UAs from the UA.

### Fourth Embodiment

The third embodiment shows a configuration for synchronizing functional information with other UAs using Intent. In contrast, a fourth embodiment shows a configuration for synchronizing functional information with other UAs using Web Intents.

### Example of Sequence Diagram for Mutual Use of Functional Information in Fourth Embodiment

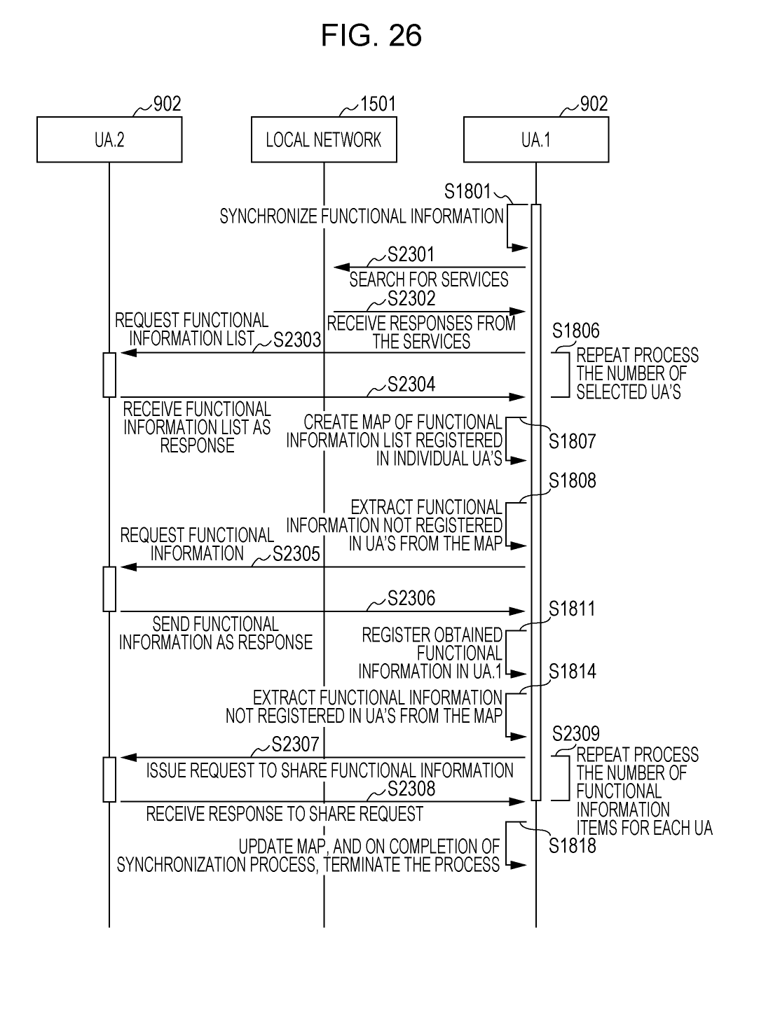

FIG. 26 is a sequence diagram of a process in which the user of the information processing terminal 501 synchronizes registered functional information between a Web browser and other Web browsers. The same steps as in FIG. 18 are given the same step numbers. Only differences from FIG. 18 will be described hereinbelow.

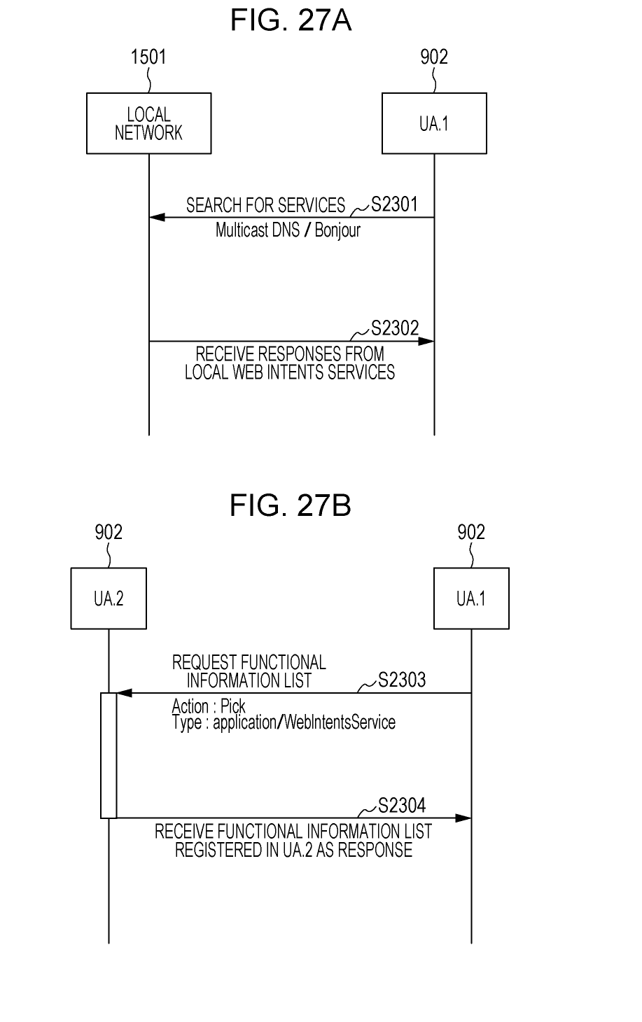

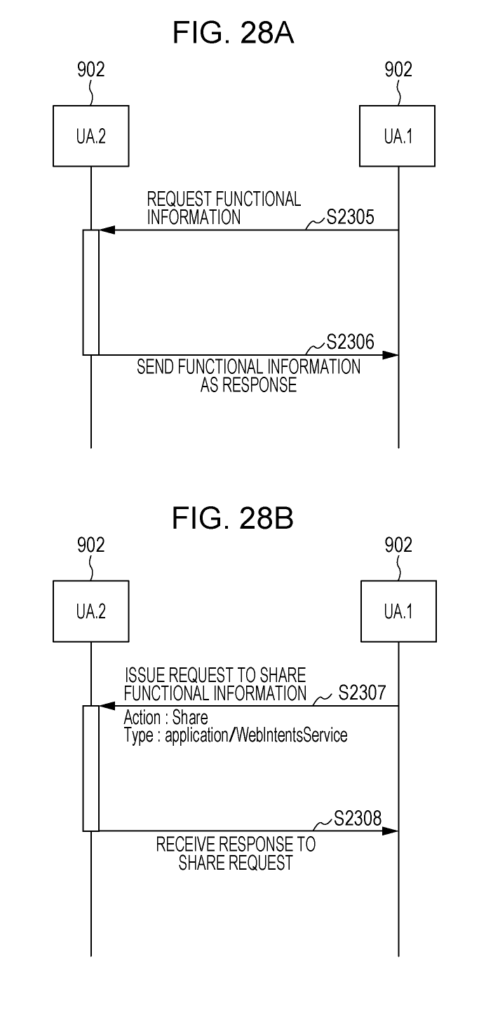

FIGS. 27A and 27B and FIGS. 28A and 28B are detailed sequence diagrams of part of the sequence in FIG. 26.

Since the process of S1801 is the same as that in FIG. 18, a description thereof will be omitted. The information processing terminal 501 in the fourth embodiment searches the local area network (local network) 1501 for applications or services (hereinafter simply referred to as services) that can provide functional information. Specifically, at S1801, upon detecting that the “service information import/share” menu 1901 (FIG. 19B) is pressed, the UA.1 searches the local network 1501 for services at S2301. The network search will be described in detail hereinbelow with reference to FIG. 27A.

As shown in FIG. 27A, at S2301, the UA.1 searches the local network 1501 for services. For example, the UA.1 searches a link local for network services using, for example, Multicast DNS in Bonjour, which is a zero configuration technique of Apple Inc.

At S2302, the UA.1 receives responses from individual services. In the fourth embodiment, since the UA.1 searches the local network 1501, the UA.1 can receive responses not only from services in the information processing terminal 501 but also from services within the service area of the local network 1501. The area of this network is not limited here. Note that the UA.1 creates a list of services that can provide functional information from the services collected as a search result and a list of services in which the functional information can be registered.

Next, at S2303 in FIG. 26, the UA.1 selects one from the list of services that can provide functional information, collected as the search result, and issues a request to obtain a list of registered functional information to an application that provides the selected service (in this example, the UA.2). At S2304, the UA.1 receives a functional information list as a response.

The process from S2303 to S2304 will be described in detail hereinbelow with reference to FIG. 27B.

As shown in FIG. 27B, at S2303, the UA.1 issues a Web Intents request in which action is “Pick” and data type is “application/Web Intents Service” to the selected application (in this example, the UA.2). At S2304, the UA.1 receives a list of functional information registered in the UA.2 from the UA.2 as a response to the Web Intents request.

Since the subsequent process from S1806 to S1808 is the same as that in FIG. 18, descriptions thereof will be omitted.

Subsequently, at S2305, the UA.1 issues a request to obtain functional information that is not registered in the UA.1 to a service that manages the functional information (in this example, the UA.2) as a Web Intents request. At S2306, the UA.2 returns the functional information as a response to the acquisition request at S2305.

The process from S2305 to S2306 will be described in detail hereinbelow with reference to FIG. 28A.

As shown in FIG. 28A, at S2305, the UA.1 issues a Web Intents request to obtain specific functional information (functional information that is not registered in the UA.1), for action “Pick” and data type “Web Intents Service”. At S2306, the UA.1 receives the designated functional information from the UA.2 as a response to the Web Intents request issued at S2305.

Since the subsequent processes S1811 and S1814 are the same as those in FIG. 18, descriptions thereof will be omitted. Although in the sequence diagram in FIG. 18, at S1812 and S1813, the UA.1 requests a list of applications in which the functional information can be registered using Intent, these processes are not performed in the sequence in FIG. 26. This is because, information can be collected during the search at S2301 to S2302 in the sequence in FIG. 26, and thus, there is no need to obtain a list of applications in which the functional information can be registered by searching again.

Subsequently, at S2307, the UA.1 issues a request to register the functional information to the individual services. At S2308, the UA.1 receives a response to the request issued at S2307.

The process from S2307 to S2308 will be described in detail hereinbelow with reference to FIG. 28B.

As shown in FIG. 28B, at S2307, the UA.1 issues a Web Intents request in which action is “Share” and data type is “Web Intents Service” to register the specific functional information (functional information not registered in the target service (in this example, UA.2) to the UA.2. At S2308, a registration result is returned to the UA.1 as a response to the Web Intents request issued at S2307.

As shown at S2309 in FIG. 26, the UA.1 executes the process from S2307 to S2308 by the number of items of functional information extracted at S1814 for each of services in which the functional information can be registered, and goes to S1818. Upon completion of the process of importing/sharing functional information performed by the UA.1, the process ends.

As described above, in the case where a plurality of UAs are present in an identical information processing terminal, the fourth embodiment allows the user, by issuing an instruction from a UA at desired timing using Web Intent, to obtain functional information that is not registered in the UA from another one or more UAs and register it, and to provide functional information that is not registered in the other UAs to the other UAs from the UA.

The third and fourth embodiments show a configuration in which the process of obtaining/sharing functional information is executed upon detecting that the “service information import/share” menu 1901 is pressed by the user. Alternatively, the process of obtaining/sharing functional information may be regularly executed depending on the settings. This allows mutual use of functional information to be achieved automatically in a plurality of relay functions even if no user instruction is given.

### Fifth Embodiment

The above embodiments show configurations for mutual use of functional information among applications installed in the information processing terminal 501. The mutual use in the first and second embodiments refers to registration to the other applications, and in the third and fourth embodiments, refers to import from the other applications and registration to the other applications. However, the partners of mutual use of functional information need not always be applications but may be services on the Internet.

For example, for the first and second embodiments, when registering functional information in a Web browser or UA, the functional information is registered also in services that manage a functional information list on the Internet. For the third and fourth embodiments, when the process of “importing/sharing a service” is executed, functional information is obtained/provided from/to a service that manages functional information on the Internet. This allows a functional information list to be shared not only among the applications, thus providing the same benefits as in the first to fourth embodiments.

### Sixth Embodiment

As shown in the second and fourth embodiments, when a functional information list is to be obtained using Web Intents, functional information that can be used in one Web browser cannot be sometimes used in another Web browser that requests the function. For example, suppose that the URL of a function that a service in the information processing terminal 501 provides is a local loopback address (http://127.0.0.1/). Even if functional information including such URL is provided to a requestor Web browser, the Web browser (the requestor Web browser) cannot use a function provided by the service corresponding to the functional information over a network.

In such a case, the providing-side Web browser provides only usable functional information depending on the conditions of the functional-information requesting side (requestor). Another example of the function provided by the service includes not only the URL but also action and type. Thus, the providing side may provide only functional information that the requestor can use depending on the action and type that the requestor requests. Such configurations can prevent functional information that the requestor cannot use from being uselessly registered, as described above, thus enhancing the user convenience.

There is also a workaround for a case where a Web browser that has received functional information determines whether the functional information can be used, and if it cannot be used, the functional information is not displayed to the user as an option. This configuration can also prevent functional information that the requestor cannot use from being uselessly registered, thus enhancing the user convenience.

### Seventh Embodiment

The third and fourth embodiments show configurations for achieving mutual use of functional information in which functional information registered in a first Web browser is requested to be registered in a second Web browser, and conversely, functional information registered in a second Web browser is imported to a first Web browser. This allows integration of registered functional information. Another effective method for mutual use is synchronizing functional information managed by a plurality of Web browsers. Functional information that is newly registered in a Web browser and functional information deleted from a Web browser are individually stored, and when the process of “service information import/share” is executed, a request to register the stored newly registered functional information in the individual Web browsers is issued. The invention further includes a configuration for synchronization of functional information in which the stored deleted functional information, if registered in another Web browser, is deleted from the Web browser.

As described above, in some embodiments of the present invention, in the case where a plurality of relay functions that provide a new cooperation framework, such as Web Intents, are present in an information processing terminal, at least part of functional information can be suitably shared among the relay functions by performing control, such as causing the plurality of relay functions to execute a process of registering identical functional information. This eliminates the need for repeating registration of the same functional information for each relay function, thus enhancing the user convenience. This can improve the usability of the currently proposed new cooperation framework, such as Web Intents.

It is to be understood that the configuration and content of various data described above are not limited thereto, and various configurations contents are possible depending on the application and purpose.

While embodiments have been described, the present invention may be embodied as, for example, a system, an apparatus, a method, a program, or a storage medium. Specifically, the present invention may be applied to a system composed of a plurality of units, or an apparatus composed of one unit.

The present invention includes all combinations of the above embodiments.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-018450, filed Feb. 3, 2014, which is hereby incorporated by reference wherein in its entirety.

What is claimed is:

1. An apparatus comprising:
a plurality of relay functions configured to interconnect a client that manages data and a service that provides a function using the data over a network; and
a providing unit configured to provide a specification screen for specifying one or more relay functions that execute a process of registering functional information for calling the function,
wherein the process of registering functional information is executed by the one or more specified relay functions.

2. The apparatus according to claim 1, wherein when the process of registering functional information is performed using a first relay function, the providing unit provides the specification screen to specify a second relay function that is to perform the process of registering functional information.

3. The apparatus according to claim 2, wherein the providing unit is implemented as a function of the first relay function, and the first relay function requests the process of registering functional information from the specified second relay function.

4. The apparatus according to claim 1, wherein the specification screen is a specification screen for specifying one or more relay functions among the plurality of relay functions.

5. The apparatus according to claim 1, further comprising:
an instruction unit configured to give an instruction to execute a synchronization process for synchronizing the functional information on which the registration process is executed by the plurality of relay functions; and
a synchronizing unit configured to synchronize the functional information on which the registration process is executed by the plurality of relay functions in accordance with an instruction.

6. The apparatus according to claim 1, wherein the plurality of relay functions are provided as functions of applications operating on an operating system of the apparatus.

7. The apparatus according to claim 1, wherein the network is Internet.

8. The apparatus according to claim 1, wherein at least one of the client and the service is a function operating in the apparatus.

9. The apparatus according to claim 1, wherein the functional information includes, as category information, category information corresponding to a function of sharing data, category information corresponding to a function of editing data, category information corresponding to a function of viewing data, category information corresponding to a function of obtaining data, and category information corresponding to a function of saving data.

10. The apparatus according to claim 1, further comprising:
a searching unit configured to search for another relay function,
wherein the providing unit provides a specification screen for specifying one or more relay functions found by the searching unit as the one or more relay functions that execute the process of registering functional information for calling a function.

11. The apparatus according to claim 10, wherein the searching unit searches the apparatus or a local area network.

12. A control method for an apparatus including a plurality of relay functions configured to interconnect a client that manages data and a service that provides a function using the data over a network, the method comprising:
providing a specification screen for specifying one or more relay functions that execute a process of registering functional information for calling the function; and
registering the functional information using the one or more specified relay functions.

13. The method according to claim 12, further comprising:
providing an instruction to execute a synchronization process for synchronizing the functional information on which the registration process is executed by the plurality of relay functions; and
synchronizing the functional information on which the registration process is executed by the plurality of relay functions in accordance with an instruction.

14. The method according to claim 12, wherein the functional information includes, as category information, category information corresponding to a function of sharing data, category information corresponding to a function of editing data, category information corresponding to a function of viewing data, category information corresponding to a function of obtaining data, and category information corresponding to a function of saving data.

15. The method according to claim 12, further comprising:
searching for another relay function; and
providing a specification screen for specifying one or more relay functions found by the searching as the one or more relay functions that execute the process of registering functional information for calling a function.

16. A computer-readable storage medium on which is stored a computer program for making a computer execute a control method for an apparatus including a plurality of relay functions configured to interconnect a client that manages data and a service that provides a function using the data over a network, the method comprising:
providing a specification screen for specifying one or more relay functions that execute a process of registering functional information for calling the function; and
registering the functional information using the one or more specified relay functions.

17. The computer-readable storage medium according to claim 16, further comprising:
providing an instruction to execute a synchronization process for synchronizing the functional information on which the registration process is executed by the plurality of relay functions; and
synchronizing the functional information on which the registration process is executed by the plurality of relay functions in accordance with an instruction.

18. The computer-readable storage medium according to claim 16, wherein the functional information includes, as category information, category information corresponding to a function of sharing data, category information corresponding to a function of editing data, category information corresponding to a function of viewing data, category information corresponding to a function of obtaining data, and category information corresponding to a function of saving data.

19. The computer-readable storage medium according to claim 16, further comprising:
searching for another relay function; and
providing a specification screen for specifying one or more relay functions found by the searching as the one or more relay functions that execute the process of registering functional information for calling a function.
